(19) United States
(12) Patent Application Publication
(10) Pub. No.: US 2011/0124253 A1
(43) Pub. Date: May 26, 2011

(54) CNT-INFUSED FIBERS IN CARBON-CARBON COMPOSITES

(75) Inventors: Tushar K. SHAH, Columbia, MD (US); Harry C. MALECKI, Abingdon, MD (US); Murray N. CARSON, Essex, MD (US)

(73) Assignee: Applied NanoStructured Solutions, LLC, Baltimore, MD (US)

(21) Appl. No.: 12/945,768

(22) Filed: Nov. 12, 2010

Related U.S. Application Data
(60) Provisional application No. 61/263,805, filed on Nov. 23, 2009.

(51) Int. Cl. B32B 9/00; C01B 31/12; C01B 31/10; B32B 5/02; B82Y 30/00; B82Y 40/00

(52) U.S. Cl. 442/60; 264/29.5; 442/179; 428/292.1; 977/700; 977/902

(57) ABSTRACT

A carbon/carbon (C/C) composite includes a carbon matrix and a non-woven, carbon nanotube (CNT)-infused carbon fiber material. Where woven materials are employed, CNTs are infused on a parent carbon fiber material in a non-woven state. A C/C composite includes a barrier coating on the CNT-infused fiber material. An article is constructed from these (C/C) composites. A method of making a C/C composite includes winding a continuous CNT-infused carbon fiber about a template structure and forming a carbon matrix to provide an initial C/C composite or by dispersing chopped CNT-infused carbon fibers in a carbon matrix precursor to provide a mixture, placing the mixture in a mold, and forming a carbon matrix to provide an initial C/C composite.

This application claims the benefit of U.S. Provisional Application No. 61/263,805, filed on Nov. 23, 2009, which is hereby incorporated by reference herein.

### STATEMENT REGARDING FEDERALLY SPONSORED RESEARCH OR DEVELOPMENT

Not applicable.

### BACKGROUND AND FIELD OF THE INVENTION

The present invention generally relates to composites, and more specifically to carbon-carbon composite materials.

Carbon-carbon (C/C) composites, based on a carbon fiber reinforced graphite matrix, are used in a variety of applications. One exemplary application is in high-end disc brakes used in the aircraft and automotive industries. These brakes operate by providing friction which causes the disc and attached wheel to slow or stop. The surface temperature of contact elements in the brake system can influence brake performance and life cycle. More generally, carbon-carbon composites are used in structural applications at high temperatures, or where thermal shock resistance and/or a low coefficient of thermal expansion is useful. Other applications of C/C composites include their use as refractory materials, in hot-pressed dies, in heating elements, and in turbojet engine components, such as rocket nozzles. While C/C composites are less brittle than ceramics employed in similar applications, C/C composites can lack impact resistance.

It would be beneficial to provide C/C composite materials with improved ability to dissipate heat to improve performance and wear in tribological systems as well as improve their impact resistance. The present invention satisfies these needs and provides related advantages as well.

### SUMMARY OF THE INVENTION

In some aspects, embodiments disclosed herein relate to a carbon/carbon (C/C) composite that includes a carbon matrix and a non-woven, carbon nanotube (CNT)-infused carbon fiber material.

In some aspects, embodiments, disclosed herein relate to a C/C composite that includes a carbon matrix and a CNT-infused carbon fiber material. When such CNT-infused carbon fiber materials are woven, CNTs are infused on a parent carbon fiber material in a non-woven state.

In some aspects, embodiments disclosed herein relate to a C/C composite made by the process of growing CNTs on a spread carbon fiber tow to provide a CNT-infused carbon fiber tow, shaping the CNT-infused carbon fiber tow, and forming a carbon matrix about the shaped CNT-infused carbon fiber tow.

In some aspects, embodiments disclosed herein relate to a C/C composite that includes a carbon matrix and a CNT-infused carbon fiber material, the CNT-infused carbon fiber material including a barrier coating.

In some aspects, embodiments disclosed herein relate to an article that includes a carbon/carbon (C/C) composite. The composite includes a carbon matrix and a non-woven CNT-infused carbon fiber material.

In some aspects, embodiments disclosed herein relate to a method of making a C/C composite that a CNT-infused carbon fiber in a carbon matrix. The method includes winding a continuous CNT-infused carbon fiber about a template structure and forming a carbon matrix to provide an initial C/C composite.

In some aspects, embodiments disclosed herein relate to a method of making a C/C composite that includes a CNT-infused carbon fiber in a carbon matrix. The method includes dispersing a chopped CNT-infused carbon fibers in a carbon matrix precursor to provide a mixture, placing the mixture in a mold, and forming a carbon matrix to provide an initial C/C composite.

### BRIEF DESCRIPTION OF THE DRAWINGS

FIG. 1 shows a transmission electron microscope (TEM) image of a multi-walled CNT (MWNT) grown on AS4 carbon fiber via a continuous CVD process.

FIG. 2 shows a TEM image of a double-walled CNT (DWNT) grown on AS4 carbon fiber via a continuous CVD process.

FIG. 3 shows a scanning electron microscope (SEM) image of CNTs growing from within the barrier coating where the CNT-forming nanoparticle catalyst was mechanically infused to the carbon fiber material surface.

FIG. 4 shows a SEM image demonstrating the consistency in length distribution of CNTs grown on a carbon fiber material to within 20% of a targeted length of about 40 microns.

FIG. 5 shows a low magnification SEM of CNTs on carbon fiber demonstrating the uniformity of CNT density across the fibers within about 10%.

FIG. 6 shows a process for producing CNT-infused carbon fiber material in accordance with the illustrative embodiment of the present invention.

FIG. 7 shows how a carbon fiber material can be infused with CNTs in a continuous process to target thermal and electrical conductivity improvements.

FIG. 8 shows how carbon fiber material can be infused with CNTs in a continuous process using a “reverse” barrier coating process to target improvements in mechanical properties, especially interfacial characteristics such as shear strength.

FIG. 9 shows how carbon fiber material can be infused with CNTs in another continuous process using a “hybrid” barrier coating to target improvements in mechanical properties, especially interfacial characteristics such as shear strength and interlaminar fracture toughness.

FIG. 10 shows the effect of infused CNTs on IM7 carbon fiber on interlaminar fracture toughness. The baseline material is an unsized IM7 carbon fiber, while the CNT-Infused material is an unsized carbon fiber with 15 micron long CNTs infused on the fiber surface.

FIG. 11 shows a SEM image of a 6 mm chopped CNT-infused carbon fiber in phenolic resin molded and cured prior to carbonization.

FIG. 12 shows a SEM image of a C/C composite in the form of a C—C paper (one step pyrolysis), with 3 mm chopped fiber.

FIG. 13 shows how carbon fiber material can be infused with CNTs in another continuous process using a “hybrid” barrier coating. Subsequently, the CNT-infused carbon fiber is chopped and incorporated into a C—C paper matrix for applications such as electrodes which require improved specific surface area.

### DETAILED DESCRIPTION OF THE INVENTION

As the application of carbon-carbon (C/C) composite materials continues to expand, the demand for improving the properties of C/C composites is limited by the carbon fiber properties which are imparted to the graphitic carbon matrix. The present invention provides a carbon-carbon composite that includes a carbon matrix and a carbon nanotube (CNT)-infused carbon fiber material dispersed through at least a portion of the matrix. Such C/C composites can impart improved electrical, structural, thermal, tribological or EMI properties. More particularly, the infused CNTs on the carbon fiber material in the C/C composite can impart improved thermal shock resistance, lower the coefficient of thermal expansion and coefficient of friction, increase the modulus of elasticity, increase thermal and electrical conductivity, increase strength, and provide improved heat and abrasion resistance. C/C composites incorporating CNT-infused carbon fibers can also provide new properties such EMI shielding, not previously realized with conventional carbon fiber reinforcing materials.

While composites in the art typically employ a 60% fiber to 40% matrix ratio, the introduction of infused CNTs allows these ratios to be altered. For example, with the addition of up to about 25% CNTs by volume, the fiber portion can vary between about 10% to about 75% with the matrix range changing to about 25% to about 85%. The various ratios can alter the properties of the overall composite, which can be tailored to target one or more desired characteristics. The properties of CNTs are imparted to fibers that are reinforced with them. Utilizing these enhanced fibers in C/C composites similarly imparts increases that will vary according to the fiber fraction, but can still greatly alter the properties of C/C composites compared to those know in the art.

Carbon-carbon composites of the invention are made using the CNT-infused carbon fibers bearing CNTs selected for improved thermal, electrical, structural, tribological or other properties can be used in thermally intensive applications. CNTs are the strongest form of carbon currently known; they also have high aspect ratios, which provides a high surface area. These two factors impart a dual role for CNTs in C/C composites of the invention: 1) absorbing and emitting heat and 2) impact resistance. Because electrical conductivity can be improved the role of carbon-carbon composites can be expanded to areas which would have been previously unattainable because of stringent electrical conductivity requirements. The EMI shielding properties imparted by CNTs provides C/C composites that can be used for stealth applications and other application where EMI shielding is important.

There are various ways to alter C/C composite properties through the addition of different fiber types. However, the properties of CNTs surpass the strength value of any additive employed in the art, and CNTs have characteristics that make them thermally and electrically conductive as well as effective for EMI shielding. Because using different lengths of CNTs can result in different properties at a macroscopic level (the level at which humans would interact with the object) the customizability of C/C composites can be increased due to the increase in the variability of the carbon fiber.

Although C/C composite systems incorporating CNTs in prefabricated carbon-based structures have been described, CNT growth has proven to be substantially non-uniform. Thus, CNT growth appears in clusters with substantial sections of the substrate devoid of CNTs. Pre-fabricated structures can also suffer from reduced CNT presence at fiber-fiber junctions where reagent access can be hindered. Moreover, some such examples of pre-fabricated systems also present substantial quantities of nanofibers reducing the structural enhancements compared to a substantially all CNT structure. In some cases, CNT growth can be patchy possibly indicating poor catalyst wetting uniformity. CNTs grown on carbon-based structures can be of poor quality due, in part, to catalyst poisoning resulting in inefficient synthesis. Other issues arise due to interactions between the carbon-based substrate and the CNT growth catalyst and catalyst agglomeration at CNT growth temperatures. Agglomeration, in particular, can make tight control of CNT characteristics difficult to control.

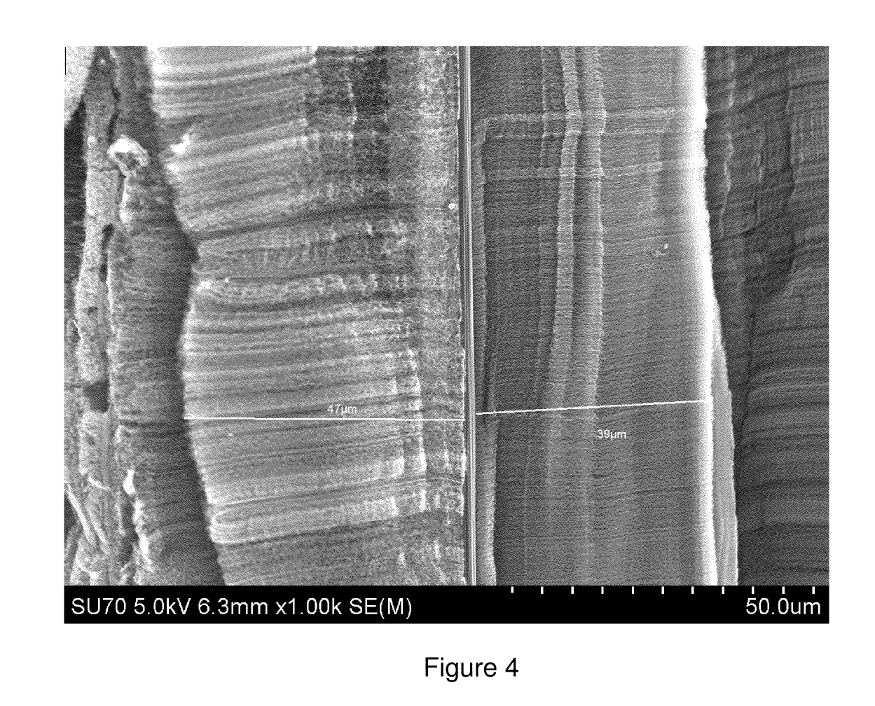

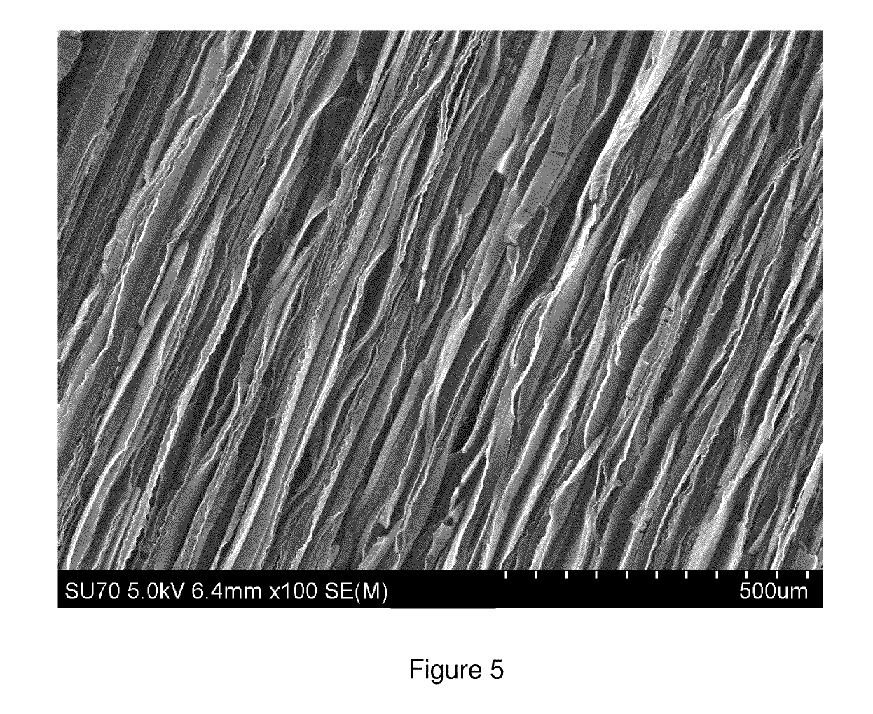

The methods employed to construct composites of the present invention involve CNT infusion on carbon fiber materials that results in CNT growth of high density and high uniformity, as exemplified by the scanning electron micrograph images shown in FIGS. 4 and 5. Achieving such growth can include the use of a barrier coating as described in US 2010-0178825, which is incorporated herein by reference in its entirety. Alternatively, or in addition to employing a barrier coating, similar quality of CNT growth on carbon fiber materials can be achieved by use of a CNT growth catalyst system employing a transition metal CNT growth catalyst in salt form in the presence of aluminum salts. Without being bound by theory, the aluminum salts can provide a similar protective barrier coating effect to that disclosed in US 2010-0178825. Both protective systems can ameliorate the detrimental interactions between the transition metal CNT growth catalyst and the surface of the carbon-based substrate on which they are disposed, thus reducing damage to fiber-based structures, reducing the chance of CNT catalyst poisoning, reducing agglomeration, and ultimately providing dramatically enhanced CNT growth.

Although the C/C manufacturing methods disclosed herein allow for CNT growth on woven and other fabric-like carbon substrates, it is also possible to prepare such CNT infused substrates in a ground up approach in which CNTs are infused on a continuous carbon tow. The continuous CNT-infusion method described below can be performed on very large scales employing, for example, 50 pound spools of carbon fiber tow. Advantageously, the process exposes individual filaments of the tow in a spreader making CNT coverage more effective about each individual fiber. The CNT-infused tow can then be woven, chopped and molded, wound over a template such as a mandrel, to provide a diverse array of possible CNT-infused structures, and subsequent C/C composites. With respect to woven structures, in particular, the fiber-fiber junctions do not suffer from poor CNT loading compared to systems that attempt to grow CNTs on pre-fabricated two- and three-dimensional structures.

As used herein, the term “carbon/carbon (C/C) composite” refers to composite structures having carbon as the predominant matrix phase element, although it does not preclude doping with non-carbon components, such a boron or phosphorus. The reinforcing phase of a C/C composite is generally a carbon fiber on which carbon nanotubes have been infused. In some embodiments, other reinforcing fiber types can be employed in addition to, or instead of carbon fibers. Exemplary alternative reinforcing fiber types can include, for example carbide fibers such as silicon carbide fiber. Alternative reinforcing fiber types can optionally include infused CNTs thereto.

As used herein, the term “non-woven,” when used in reference carbon fiber materials or CNT-infused carbon fiber materials, refers to structures lacking a weave. Non-woven structures can include continuous fibers, for example, in the form of tows, rovings, yarns, and the like. Non-woven structures can include chopped materials as well. “Carbon fiber material” refers to any material which has carbon fiber as its elementary structural component. The term encompasses fibers, filaments, yarns, tows, tows, tapes, woven and non-woven fabrics, plies, mats, and the like.

As used herein, the term “carbon matrix” refers to the bulk graphitic matrix material employed in C/C composites and a “carbon matrix precursor” is any material that can be converted to a carbon matrix. A carbon matrix can be formed, for example, by pyrolysis and/or chemical vapor deposition or chemical vapor infiltrations (CVD or CVI) methods using organic resins, tar, pitch, or, when employing CVD and CVI methods, other hydrocarbon sources, including gases such as acetylene, ethylene, and the like. The density of the carbon matrix can vary depending on the method employed in its formation.

As used herein, the term “carbon nanotube” (CNT, plural CNTs) refers to any of a number of cylindrically-shaped allotropes of carbon of the fullerene family including single-walled carbon nanotubes (SWNTs), double-walled carbon nanotubes (DWNTs), multi-walled carbon nanotubes (MWNTs). CNTs can be capped by a fullerene-like structure or open-ended. CNTs include those that encapsulate other materials.

As used herein, the term “infused” means bonded and “infusion” means the process of bonding. Such bonding can involve direct covalent bonding, ionic bonding, pi-pi, and van der Waals force-mediated physisorption. For example, the CNTs can be directly bonded to the fiber carrier covalently. Bonding can be indirect, such as CNT infusion to a fiber via a passivating barrier coating and/or an intervening transition metal nanoparticle disposed between the CNT and the carbon fiber. In the CNT-infused carbon fibers disclosed herein, the carbon nanotubes can be “infused” to the fiber directly or indirectly. The particular manner in which a CNT is “infused” to a carbon fiber material is referred to as a “bonding motif.” Regardless of the actual bonding motif of the CNT-infused carbon fiber, the infusion process described herein provides a more robust bonding than simply applying loose, pre-fabricated CNTs to a fiber. In this respect, the synthesis of CNTs on catalyst-laden fiber substrates provides “infusion” that is stronger than van der Waals adhesion alone. CNT-infused fibers made by the processes described herein further below can provide a network of highly entangled branched carbon nanotubes which can exhibit a shared-wall motif between neighboring CNTs, especially at higher densities. In some embodiments, growth can be influenced, for example, in the presence of an electric field to provide alternative growth morphologies. The growth morphology at lower densities can also deviate from a branched shared-wall motif, while still providing strong infusion to the fiber.

As used herein, the term “organic resin” refers to any polymeric, oligomeric, or other carbon rich material that is relatively non-volatile and which can serve as a precursor source of carbon to form the carbon matrix material of C/C composites of the invention. Such resins include, without limitation, phenolic resins,

As used herein, the term “matrix modifier” refers to an additive to the bulk graphitic matrix of a C/C composite. Matrix modifiers can serve to protect the bulk matrix material against, for example, oxidation.

As used herein, the term “carbon nanostructure” refers to any carbon allotropic structure having at least one dimension in the nanoscale. Nanoscale dimensions can include any dimension ranging from between about 0.1 nm to about 1000 nm.

As used herein the term “spoolable dimensions” refers to carbon fiber materials having at least one dimension that is not limited in length, allowing for the material to be stored on a spool or mandrel. Carbon fiber materials of “spoolable dimensions” have at least one dimension that indicates the use of either batch or continuous processing for CNT infusion as described herein. One carbon fiber material of spoolable dimensions that is commercially available is exemplified by AS4 12 k carbon fiber tow with a tex value of 800 (1 tex=1 g/1,000 m) or 620 yard/lb (Grafil, Inc., Sacramento, Calif.). Commercial carbon fiber tow, in particular, can be obtained in 5, 10, 20, 50, and 100 lb. (for spools having high weight, usually a 3 k/12K tow) spools, for example, although larger spools may require special order. Processes of the invention operate readily with 5 to 20 lb. spools, although larger spools are usable. Moreover, a pre-process operation can be incorporated that divides very large spoolable lengths, for example 100 lb. or more, into easy to handle dimensions, such as two 50 lb spools.

As used herein “uniform in length” refers to length of CNTs grown in a reactor. “Uniform length” means that the CNTs have lengths with tolerances of plus or minus about 20% of the total CNT length or less, for CNT lengths varying from between about 1 micron to about 500 microns. At very short lengths, such as 1-4 microns, this error may be in a range from between about plus or minus 20% of the total CNT length up to about plus or minus 1 micron, that is, somewhat more than about 20% of the total CNT length.

As used herein “uniform in distribution” refers to the consistency of density of CNTs on a carbon fiber material. “Uniform distribution” means that the CNTs have a density on the carbon fiber material with tolerances of plus or minus about 10% coverage defined as the percentage of the surface area of the fiber covered by CNTs. This is equivalent to ±1500 CNTs/μm2 for an 8 nm diameter CNT with 5 walls. Such a figure assumes the space inside the CNTs as fillable.

As used herein, the term “transition metal” refers to any element or alloy of elements in the d-block of the periodic table. The term “transition metal” also includes salt forms of the base transition metal element such as oxides, carbides, nitrides, and the like.

As used herein, the term “nanoparticle” or NP (plural NPs), or grammatical equivalents thereof refers to particles sized between about 0.1 to about 100 nanometers in equivalent spherical diameter, although the NPs need not be spherical in shape. Transition metal NPs, in particular, serve as catalysts for CNT growth on the carbon fiber materials.

As used herein, the term “sizing agent,” “fiber sizing agent,” or just “sizing,” refers collectively to materials used in the manufacture of carbon fibers as a coating to protect the integrity of carbon fibers, provide enhanced interfacial interactions between a carbon fiber and a matrix material in a composite, and/or alter and/or enhance particular physical properties of a carbon fiber. In some embodiments, CNTs infused to carbon fiber materials behave as a sizing agent.

As used herein, the term “material residence time” refers to the amount of time a discrete point along a fiber material of spoolable dimensions is exposed to CNT growth conditions during the CNT infusion processes described herein. This definition includes the residence time when employing multiple CNT growth chambers.

As used herein, the term “linespeed” refers to the speed at which a fiber material of spoolable dimensions can be fed through the CNT infusion processes described herein, where linespeed is a velocity determined by dividing CNT chamber(s) length by the material residence time.

In some embodiments, the present invention provides a carbon/carbon (C/C) composite that includes a carbon matrix and a non-woven, carbon nanotube (CNT)-infused carbon fiber material. In some such composites, the non-woven, CNT-infused carbon fiber material is a continuous CNT-infused carbon fiber material, such as a wound tow, while in other embodiments, the non-woven, CNT-infused carbon fiber material is a chopped CNT-infused carbon fiber material. In the case of chopped fiber systems, the chopped fibers can be fabricated from a continuous CNT-infused tow, which creates manufacturing efficiency since a single CNT-infusion process is being used to make both continuous and chopped materials.

C/C composites can be formed by impregnating a fibrous material with an organic resin and then heating or pyrolyzing the mixture to carbonizing temperatures. A variety of methods and carbon matrix precursor materials for making carbon/carbon composites have been described, such as those disclosed in Buckley, John D. and Edie, Dan D., ed., Carbon-Carbon Materials and Composites, Noyes Publications, Park Ridge, N.J. (1993); Delmonte, John, Technology of Carbon and Graphite Fiber Composites, Van Nostrand Reinhold Company, New York, N.Y. (1981); Schmidt et al, “Evolution of Carbon-Carbon Composites (CCC)” SAMPE Journal, Vol. 32, No. 4, July/August 1996, pp 44-50; “Expanding Applications Reinforce the Value of Composites” High Performance Composites 1998 Sourcebook; U.S. Pat. Nos. 3,914,395, 4,178,413, 5,061,414, 4,554,024 and 5,686,027, all of which are incorporated herein by reference in their entirety. The C/C composites of the invention can employ any precursor carbon source known in the art to fabricate the carbon matrix. In some embodiments, the carbon matrix is derived from an organic resin. Organic resins for C/C formation include, for example, phenolic resins, phthalonitriles, and mixed phenolic-furfuryl alcohol. In some embodiments the carbon matrix is derived from a tar or pitch. Hydrocarbon materials, such as those employed in chemical vapor deposition/chemical vapor infiltration (CVD/CVI) can also be used to generate the carbon matrix.

The C/C composites of the invention can include any number of additives within the carbon matrix. In some embodiments, the C/C composite can further include a matrix modifier that includes phosphorus or boron. Such matrix modifiers can act to reduce the detrimental effects of oxidation that can be problematic at elevated temperatures. Other additives to C/C composites of the invention can include a dopant carbon nanostructure selected from the group consisting of loose CNTs, fullerenes, nano-onions, nanoflakes, nanoscrolls, nanopaper, nanofibers, nanohorns, nanoshells, nanowires, nanosprings, nanocrystals, nanodiamonds, bucky diamond, nanocontainers, nanomesh, nanosponges, nano-scaled graphene plates (NGPs), and nanobeads. In some embodiments, a dopant carbon nanostructure can be fabricated in situ during densification of the carbon matrix, while in other embodiments, the dopant carbon nanostructures can be added as pre-fabricated components prior to densification and, in some embodiments, even prior to a first pyrolysis step in prior to densification. In some embodiments, one or more of the aforementioned carbon nanostructures and any matrix modifiers can be added during any initial pyrolysis step and during any number of subsequent densification steps.

CNT-infused carbon fibers have been described in US 2010-0178825, which is incorporated herein by reference in its entirety. Such CNT-infused carbon fiber materials are exemplary of the types that can be used as a reinforcing material in a C/C composite. Other CNT-infused fiber-type materials have been described and can be employed in mixed composite systems. Such mixed fiber-carbon matrix composites can include, for example, CNT-infused glass fibers, metal fibers, ceramic fibers, and organic fibers, such as aramid fibers. In the CNT-infusion processes disclosed in the above-referenced application, carbon fiber materials are modified to provide a layer (typically no more than a monolayer) of CNT-initiating catalyst nanoparticles on the fiber. The catalyst-laden fiber is then exposed to a CVD-based process used to grow CNTs continuously, in line. The CNTs grown are infused to the fiber material. The resultant CNT-infused fiber material is itself a composite architecture. CNT density made by this process provides radial growth of CNTs about the fiber axis. The densities achieved by the continuous process are higher, in part, due to the use of barrier coatings on the carbon fiber material that attenuate the CNT catalyst nanoparticle interaction with the carbon fiber.

After processing of the fiber the carbon-carbon composite can be created normally using any process known in the art, such as pyrolysis, chemical vapor deposition (CVD) and chemical vapor infiltration (CVI). In the case of pyrolysis, CNT-infused carbon fibers can replace the usual unfunctionalized carbon fibers, the resin can be poured and carbon forms around the CNT infused fibers as it would using unfunctionalized fibers. CVD (Chemical Vapor Deposition) can be performed in at least two ways: One method is to provide a pre-fabricated CNT-infused carbon fiber and then deposit graphitic carbon around the CNT-infused fibers until the composite is complete. A second method is to grow the CNTs to generate the CNT-infused fibers, and use the same gases used for CVD CNT growth on the fibers to continue to deposit the graphite matrix. Amorphous carbon deposition can occur after or during CNT growth.

Thus, using the CNT-infused carbon fibers need not change the C/C composite production process. The second option for CVD can be beneficial under certain conditions, such as when it is desirable that the CNTs are not bound to the composite matrix itself. Additionally one can choose to customize the CNTs grown during CVD growth. The CNT-infused carbon fibers can be customized based on the type, orientation and length of CNT created, so the fibers allow the creation of very specific composites to address precisely the needs of a particular application.

C/C composites can be manufactured with different orientation of the reinforcing CNT-infused carbon fibers. For example, the fibers can be unidirectional in structure, bi-directional structure, such as cloth made of multiple carbon fiber yarns, multi-directional structure 3D. Multi-directional reinforcement can provide maximum level of mechanical properties in the directions of the woven structure.

The CNTs infused on portions of the fiber material are generally uniform in length. Uniform length means that the CNTs have lengths with tolerances of plus or minus about 20% of the total CNT length or less, for CNT lengths varying from between about 1 micron to about 500 microns. At very short lengths, such as 1-4 microns, this error may be in a range from between about plus or minus 20% of the total CNT length up to about plus or minus 1 micron, that is, somewhat more than about 20% of the total CNT length. The C/C composites of the invention can have CNTs on the CNT-infused fiber material ranging in length from between about 80 to about 500 microns in some embodiments, from between about 250 to about 500 microns, in other embodiments, and from between about 50 to about 250 microns, in still other embodiments, including any lengths in between and fractions thereof. For thermal conductivity enhancements, it can be useful to employ CNTs having a length in a range from between about 80 to about 500 microns, in some embodiments, and from between about 250 microns to about 500 microns in other embodiments, including 250 microns, 300 microns, 350 microns, 400 microns, 450 microns, and 500 microns, including all values in between and fractions thereof. Similarly, for impact enhancements, it can be useful to employ CNTs having a length in a range from between about 50 to about 250 microns, including 50 microns, 100 microns, 150 microns, 200 microns, and 250 microns, including all values in between and fractions thereof. In some embodiments, a C/C composite can be tailored to have different length CNTs in different portions differing property enhancements in different portions of an article. Thus, for example, a first portion of a C/C composite can have CNTs with lengths in a range from between about 50 to about 250 microns and a second portion of the C/C composite can have CNTs with lengths in a range from between about 250 to about 500 microns. In some such embodiments, CNTs in a first portion can include, for example, a surface of a composite article, while CNTs in a second portion can include, for example, at the core of the composite article.

In some embodiments, the CNT-infused carbon fibers can impart other properties to the C/C composites, such as electrical conductivity and EMI shielding, which can be substantially enhanced compared to conventional reinforcing carbon fibers. The CNT-infused fiber can be tailored with specific types of CNTs on the surface of fiber such that various properties can be achieved. For example, the electrical properties can be modified by applying various types, diameter, length, and density CNTs on the fiber. CNTs of a length which can provide proper CNT to CNT bridging is used to create percolation pathways which improve composite conductivity. Because fiber spacing is typically equivalent to or greater than one fiber diameter, from about 5 to about 50 microns, CNTs can be at least half this length to achieve effective electrical pathways. Shorter length CNTs can be used to enhance structural properties. In some embodiments, a CNT-infused carbon fiber material includes CNTs of varying lengths along different sections of the same fiber material. When used as a C/C composite reinforcement, such multifunctional CNT-infused fibers enhance more than one property of the C/C composite in which they are incorporated.

In some embodiments, a first amount of carbon nanotubes is infused to the carbon fiber material. This amount is selected such that the value of at least one property selected from the group consisting of tensile strength, Young's Modulus, shear strength, shear modulus, toughness, compression strength, compression modulus, density, EM wave absorptivity/reflectivity, acoustic transmittance, electrical conductivity, and thermal conductivity of the carbon nanotube-infused fiber material differs from the value of the same property of the fiber material itself. Any of these properties of the resultant CNT-infused carbon fiber material can be imparted to the final C/C composite.

Tensile strength can include three different measurements: 1) Yield strength which evaluates the stress at which material strain changes from elastic deformation to plastic deformation, causing the material to deform permanently; 2) Ultimate strength which evaluates the maximum stress a material can withstand when subjected to tension, compression or shearing; and 3) Breaking strength which evaluates the stress coordinate on a stress-strain curve at the point of rupture. Composite shear strength evaluates the stress at which a material fails when a load is applied perpendicular to the fiber direction. Compression strength evaluates the stress at which a material fails when a compressive load is applied.

Multiwalled carbon nanotubes, in particular, have the highest tensile strength of any material yet measured, with a tensile strength of 63 GPa having been achieved. Moreover, theoretical calculations have indicated possible tensile strengths of CNTs of about 300 GPa. Thus, CNT-infused fiber materials are expected to have substantially higher ultimate strength compared to the parent fiber material. As described above, the increase in tensile strength will depend on the exact nature of the CNTs used as well as the density and distribution on the fiber material. CNT-infused fiber materials can exhibit a two to three times increase in tensile properties, for example. Exemplary CNT-infused carbon fiber materials can have as high as three times the shear strength as the parent unfunctionalized fiber material and as high as 2.5 times the compression strength. Such increases in the strength of the reinforcing fiber material translate to increased strength in a C/C composite in which the CNT-infused fiber is incorporated.

Young's modulus is a measure of the stiffness of an isotropic elastic material. It is defined as the ratio of the uniaxial stress over the uniaxial strain in the range of stress in which Hooke's Law holds. This can be experimentally determined from the slope of a stress-strain curve created during tensile tests conducted on a sample of the material.

Electrical conductivity or specific conductance is a measure of a material's ability to conduct an electric current. CNTs with particular structural parameters such as the degree of twist, which relates to CNT chirality, can be highly conducting, thus exhibiting metallic properties. A recognized system of nomenclature (M. S. Dresselhaus, et al. Science of Fullerenes and Carbon Nanotubes, Academic Press, San Diego, Calif. pp. 756-760, (1996)) has been formalized and is recognized by those skilled in the art with respect to CNT chirality. Thus, for example, CNTs are distinguished from each other by a double index (n,m) where n and m are integers that describe the cut and wrapping of hexagonal graphite so that it makes a tube when it is wrapped onto the surface of a cylinder and the edges are sealed together. When the two indices are the same, m=n, the resultant tube is said to be of the “arm-chair” (or n,n) type, since when the tube is cut perpendicular to the CNT axis only the sides of the hexagons are exposed and their pattern around the periphery of the tube edge resembles the arm and seat of an arm chair repeated n times. Arm-chair CNTs, in particular SWNTs, are metallic, and have extremely high electrical and thermal conductivity. In addition, such SWNTs have-extremely high tensile strength.

In addition to the degree of twist CNT diameter also effects electrical conductivity. As described above, CNT diameter can be controlled by use of controlled size CNT-forming catalyst nanoparticles. CNTs can also be formed as semi-conducting materials. Conductivity in multi-walled CNTs (MWNTs) can be more complex. Interwall reactions within MWNTs can redistribute current over individual tubes non-uniformly. By contrast, there is no change in current across different parts of metallic single-walled nanotubes (SWNTs). Carbon nanotubes also have very high thermal conductivity, comparable to diamond crystal and in-plane graphite sheet.

The CNTs infused on portions of the fiber material are substantially uniform in distribution as well in addition to being substantially uniform in length. Uniform in distribution refers to the consistency of density of CNTs on a fiber material. Uniform distribution means that the CNTs have a density on the fiber material with tolerances of plus or minus about 10% coverage defined as the percentage of the surface area of the fiber covered by CNTs. In some embodiments, a tolerance is in a range from between about plus or minus 1500 CNTs per micron square for an 8 nm diameter CNT with 5 walls. Such a figure assumes the space inside the CNTs as fillable. In some embodiments, the C/C composites of the invention have a CNT density on a CNT-infused carbon fiber material in a range from between about 100 CNTs per micron squared to about 10,000 CNTs per micron squared. In other embodiments, a CNT density on a CNT-infused carbon fiber material is in a range from between about 100 CNTs per micron squared to about 5,000 CNTs per micron squared.

In some embodiments, the C/C composites of the invention can have CNTs in the CNT-infused fiber material present in a range from between about 20 percent by weight to about 40 percent by weight of the CNT-infused fiber, including 20, 21, 22, 23, 24, 25, 26, 27, 28, 29, 30, 31, 32, 33, 34, 35, 36, 37, 38, 39, and 40 percent by weight of the CNT-infused fiber, including fractions thereof. In some embodiments, the C/C composites of the invention can have CNTs in the CNT-infused fiber material present in a range from between about 35 percent by weight to about 40 percent by weight of the CNT-infused fiber, and in a range from between about 15 percent by weight to about 30 percent by weight of the CNT-infused fiber, in other embodiments. In some embodiments, the C/C composites of the invention can have CNT-infused fiber material present in a range from between about 10 percent to about 60 percent of the composite volume, and from between about 30 percent to about 40 percent of the composite volume, in other embodiments. In some embodiments, the CNT infused fiber material includes about 10, 15, 20, 25, 30, 35, 40, 45, 50, 55, 60 percent of the composite volume, including all values in between and fractions thereof.

In some embodiments, the present invention provides a C/C composite comprising a carbon matrix and a CNT-infused carbon fiber material. In some such embodiments, where a CNT-infused carbon fiber material is woven, the CNTs can be infused on a parent carbon fiber material in a non-woven state. Thus, where woven materials are to be used in a C/C composite article. CNT density and loading can benefit from a ground up approach to two- and three-dimensional structures, by loading the CNTs in a substantially one-dimensional precursor structure. This can provide C/C composites with more uniform CNT density throughout higher dimensional constructs. Thus, in some embodiments, the present invention provides a C/C composite made by the process of growing CNTs on a spread carbon fiber tow to provide a CNT-infused carbon fiber tow, shaping the CNT-infused carbon fiber tow, and forming a carbon matrix about the shaped CNT-infused carbon fiber tow. CNTs are grown on carbon fibers as described above, and in further detail below. Shaping the CNT-infused fiber can include for example, winding a continuous CNT-infused carbon fiber tow about a template or mandrel structure. Winding can include spreading the tow during winding about the template. Shaping can also include chopping the fiber, dispersing it in a carbon composite matrix precursor and placing it in a mold. For example, a mold might include an structure used in disc break production. Shaping can also include any weaving, or formation of any fabric structures from parent carbon fiber tows. Shaping can also include combinations of weaving with template wrapping, or weaving and cutting with subsequent placement in molds. Forming the carbon matrix can include one or more steps of pyrolysis, CVD, CVI, and combinations thereof.

In some embodiments, the present invention provides an article that includes a carbon/carbon (C/C) composite of the invention including a carbon matrix and a non-woven CNT-infused carbon fiber material. In some embodiments, the article employs a non-woven CNT-infused carbon fiber material that is continuous. In some embodiments, the article employs a non-woven CNT-infused carbon fiber material that is chopped. Depending on the exact downstream application of the article, the composite structure can include a protective coating, a matrix modifier, or mixtures thereof.

In some embodiments, a protective coating can include a metal or metalloid in a form selected from an oxide, carbide, nitride, silicide, and combinations thereof. Exemplary protective coatings can includes, without limitation, chloride oxide, silicon carbide, silicon nitride, zirconium oxide, halfnium oxide, boron carbide, chromium boride, zirconium boride, silicon boride, aluminum oxide, silicon dioxide, aluminum boride, zirconium boride-silicon carbide, yttrium silicate-silicon carbide, mullite-aluminum oxide-silicon carbide, silicon carbide-silicon-zirconium silicate, boron oxide, silicon nitride, titanium nitride, titanium boride, titanium silicide, halfnium silicide, molybdenum silicide, halfnium carbide, cerium borate-silicon carbide, zirconium silicate-boron oxide, halfnium boride-boron oxide, silicon nitride-boron nitride, silicon nitride-titanium nitride, silicon nitride-silicon carbide, silicon carbide-titanium silicide, aluminum nitride-boron nitride, self-sealing borosilicate glass, aluminum nitride-silicon nitride, titanium boride-titanium carbide, zirconium carbide-boron nitride, tungsten silicide, molybdenum silicide, tungsten-molybdenum-silicon-silicon carbide, and halfnium carbide-halfnium silicide. In some embodiments, such coatings can be used to reduce oxidation of the C/C composite in high temperature applications. In this regard, the article can also have a composite that has a matrix modifier, such as boron or phosphorus, as described above.

In some embodiments, an article of invention includes a brake rotor. In some embodiments an article of the invention includes a portion of a hypersonic aircraft. The demands and context of each article can dictates the exact composition of the C/C composite used. For example, in some embodiments, a brake rotor can be fabricated using a chopped CNT-infused fiber material. In hypersonic aircraft parts, continuous CNT-infused fiber materials can be used to mold large parts using winding techniques about a template structure. The demands of each application can also dictate any additives. For example, in hypersonic applications, temperature extremes can be substantial to rise to the level of adding protective coatings and matrix modifiers as described herein above.

In some embodiments, the present invention provides a method of making a C/C composite that includes a CNT-infused carbon fiber in a carbon matrix. The method can include winding a continuous CNT-infused carbon fiber about a template structure; and forming a carbon matrix to provide an initial C/C composite. The step of forming a carbon matrix can include infusing the wound continuous CNT-infused carbon fiber material with a carbon matrix precursor followed by pyrolysis of the carbon matrix precursor. In some embodiments, the carbon matrix precursor is an organic resin, such as a phenolic resin. In some embodiments, the carbon matrix precursor is a tar or pitch. In some embodiments, the winding step includes wet winding with the carbon matrix precursor and the forming step includes pyrolysis. Thus, methods of the invention can employ either dry winding or wet winding of a continuous CNT-infused fiber material. In some embodiments, forming the carbon matrix can include chemical vapor deposition (CVD) and/or chemical vapor infiltration (CVI).

After initial formation of an initial C/C composite through a first pyrolysis or CVD/CVI step, the initial C/C composite can be subject to one or more densifying steps. Densifying can include subjecting said initial C/C composite to repeated cycles of infusion with a carbon matrix precursor and pyrolysis. In some embodiments, densifying can include subjecting the C/C composite to repeated cycles of CVD and/or CVI. In some embodiments, densifying includes disposing a CNT growth catalyst on the initial C/C composite and subjecting the catalyst-laden initial C/C composite to CVD conditions that include a temperature ramp that includes temperatures for promoting CNT growth up to temperatures for carbonization. In some such embodiments, the formation of CNTs and other carbon nanostructured dopants, as described herein above, can be fabricated in situ during densification.

In some embodiments, the present invention provides a method of making a C/C composite that includes a CNT-infused carbon fiber in a carbon matrix. The method includes: dispersing chopped CNT-infused carbon fibers in a carbon matrix precursor to provide a mixture; placing said mixture in a mold; and forming a carbon matrix to provide an initial C/C composite. In some such embodiments, the step of forming a carbon matrix includes pyrolyzing the carbon matrix precursor which can an organic resin, such as a phenolic resin or a tar or pitch.

As with continuous CNT-infused fiber material composites, the chopped CNT-infused carbon fiber composite materials can also be subject to a densifying of the initial C/C composite. Such densifying can include subjecting said initial C/C composite to repeated cycles of infusion with a carbon matrix precursor and pyrolysis and/or repeated cycles of CVD. Densifying can also include disposing a CNT growth catalyst on the initial C/C composite and subjecting the catalyst-laden initial C/C composite to CVD conditions that include a temperature ramp comprising temperatures for promoting CNT growth up to temperatures for carbonization.

The present invention provides C/C composites which utilize carbon nanotube-infused CNT-infused carbon fiber materials. The infusion of CNTs to the carbon fiber material can serve many functions in addition to those described above, for example, CNTs can also act as a sizing agent to protect against damage from moisture, oxidation, abrasion, and compression. A CNT-based sizing can also enhance the interface between the carbon fiber material and the carbon matrix material in the composite. The processes employed to make CNT-infused carbon fiber materials provide CNTs with substantially uniform length and distribution to impart their useful properties uniformly over the carbon fiber material that is being modified. Furthermore, the processes disclosed herein are suitable for the generation of CNT-infused carbon fiber materials of spoolable dimensions.

The processes disclosed herein can be applied to nascent carbon fiber materials generated de novo before, or in lieu of, application of a typical sizing solution to the carbon fiber material. Alternatively, the processes disclosed herein can utilize a commercial carbon fiber material, for example, a carbon tow, that already has a sizing applied to its surface. In such embodiments, the sizing can be removed to provide a direct interface between the carbon fiber material and the synthesized CNTs, although a barrier coating and/or transition metal particle can serve as an intermediate layer providing indirect infusion, as explained further below. After CNT synthesis further sizing agents can be applied to the carbon fiber material as desired.

The processes described herein allow for the continuous production of carbon nanotubes of uniform length and distribution along spoolable lengths of tow, tapes, fabrics and other 3D woven structures. While various mats, woven and non-woven fabrics and the like can be functionalized by processes of the invention, it is also possible to generate such higher ordered structures from the parent tow, yarn or the like after CNT functionalization of these parent materials. For example, a CNT-infused woven fabric can be generated from a CNT-infused carbon fiber tow.

In some embodiments, the present invention provides a composite composition that includes a carbon nanotube (CNT)-infused carbon fiber material. The CNT-infused carbon fiber material includes a carbon fiber material of spoolable dimensions, a barrier coating conformally disposed about the carbon fiber material, and carbon nanotubes (CNTs) infused to the carbon fiber material. The infusion of CNTs to the carbon fiber material can include a bonding motif of direct bonding of individual CNTs to the carbon fiber material or indirect bonding via a transition metal NP, barrier coating, or both.

Without being bound by theory, transition metal NPs, which serve as a CNT-forming catalyst, can catalyze CNT growth by forming a CNT growth seed structure. In one embodiment, the CNT-forming catalyst can remain at the base of the carbon fiber material, locked by the barrier coating, and infused to the surface of the carbon fiber material. In such a case, the seed structure initially formed by the transition metal nanoparticle catalyst is sufficient for continued non-catalyzed seeded CNT growth without allowing the catalyst to move along the leading edge of CNT growth, as often observed in the art. In such a case, the NP serves as a point of attachment for the CNT to the carbon fiber material. The presence of the barrier coating can also lead to further indirect bonding motifs. For example, the CNT forming catalyst can be locked into the barrier coating, as described above, but not in surface contact with carbon fiber material. In such a case a stacked structure with the barrier coating disposed between the CNT forming catalyst and carbon fiber material results. In either case, the CNTs formed are infused to the carbon fiber material. In some embodiments, some barrier coatings will still allow the CNT growth catalyst to follow the leading edge of the growing nanotube. In such cases, this can result in direct bonding of the CNTs to the carbon fiber material or, optionally, to the barrier coating. Regardless of the nature of the actual bonding motif formed between the carbon nanotubes and the carbon fiber material, the infused CNT is robust and allows the CNT-infused carbon fiber material to exhibit carbon nanotube properties and/or characteristics.

Again, without being bound by theory, when growing CNTs on carbon fiber materials, the elevated temperatures and/or any residual oxygen and/or moisture that can be present in the reaction chamber can damage the carbon fiber material. Moreover, the carbon fiber material itself can be damaged by reaction with the CNT-forming catalyst itself. That is the carbon fiber material can behave as a carbon feedstock to the catalyst at the reaction temperatures employed for CNT synthesis. Such excess carbon can disturb the controlled introduction of the carbon feedstock gas and can even serve to poison the catalyst by overloading it with carbon. The barrier coating employed in the invention is designed to facilitate CNT synthesis on carbon fiber materials. Without being bound by theory, the coating can provide a thermal barrier to heat degradation and/or can be a physical barrier preventing exposure of the carbon fiber material to the environment at the elevated temperatures. Alternatively or additionally, it can minimize the surface area contact between the CNT-forming catalyst and the carbon fiber material and/or it can mitigate the exposure of the carbon fiber material to the CNT-forming catalyst at CNT growth temperatures.

Compositions having CNT-infused carbon fiber materials are provided in which the CNTs are substantially uniform in length. In the continuous process described herein, the residence time of the carbon fiber material in a CNT growth chamber can be modulated to control CNT growth and ultimately, CNT length. This provides a means to control specific properties of the CNTs grown. CNT length can also be controlled through modulation of the carbon feedstock and carrier gas flow rates and reaction temperature. Additional control of the CNT properties can be obtained by controlling, for example, the size of the catalyst used to prepare the CNTs. For example, 1 nm transition metal nanoparticle catalysts can be used to provide SWNTs in particular. Larger catalysts can be used to prepare predominantly MWNTs.

Additionally, the CNT growth processes employed are useful for providing a CNT-infused carbon fiber material with uniformly distributed CNTs on carbon fiber materials while avoiding bundling and/or aggregation of the CNTs that can occur in processes in which pre-formed CNTs are suspended or dispersed in a solvent solution and applied by hand to the carbon fiber material. Such aggregated CNTs tend to adhere weakly to a carbon fiber material and the characteristic CNT properties are weakly expressed, if at all. In some embodiments, the maximum distribution density, expressed as percent coverage, that is, the surface area of fiber covered, can be as high as about 55% assuming about 8 nm diameter CNTs with 5 walls. This coverage is calculated by considering the space inside the CNTs as being “fillable” space. Various distribution/density values can be achieved by varying catalyst dispersion on the surface as well as controlling gas composition and process speed. Typically for a given set of parameters, a percent coverage within about 10% can be achieved across a fiber surface. Higher density and shorter CNTs are useful for improving mechanical properties, while longer CNTs with lower density are useful for improving thermal and electrical properties, although increased density is still favorable. A lower density can result when longer CNTs are grown. This can be the result of the higher temperatures and more rapid growth causing lower catalyst particle yields.

The compositions of the invention having CNT-infused carbon fiber materials can include a carbon fiber material such as a carbon filament, a carbon fiber yarn, a carbon fiber tow, a carbon tape, a carbon fiber-braid, a woven carbon fabric, a non-woven carbon fiber mat, a carbon fiber ply, and other 3D woven structures. Carbon filaments include high aspect ratio carbon fibers having diameters ranging in size from between about 1 micron to about 100 microns. Carbon fiber tows are generally compactly associated bundles of filaments and are usually twisted together to give yarns.

Yarns include closely associated bundles of twisted filaments. Each filament diameter in a yarn is relatively uniform. Yarns have varying weights described by their ‘tex,’ expressed as weight in grams of 1000 linear meters, or denier, expressed as weight in pounds of 10,000 yards, with a typical tex range usually being between about 200 tex to about 2000 tex.

Tows include loosely associated bundles of untwisted filaments. As in yarns, filament diameter in a tow is generally uniform. Tows also have varying weights and the tex range is usually between 200 tex and 2000 tex. They are frequently characterized by the number of thousands of filaments in the tow, for example 12K tow, 24K tow, 48K tow, and the like.

Carbon tapes are materials that can be assembled as weaves or can represent non-woven flattened tows. Carbon tapes can vary in width and are generally two-sided structures similar to ribbon. Processes of the present invention are compatible with CNT infusion on one or both sides of a tape. CNT-infused tapes can resemble a “carpet” or “forest” on a flat substrate surface. Again, processes of the invention can be performed in a continuous mode to functionalize spools of tape.

Carbon fiber-braids represent rope-like structures of densely packed carbon fibers. Such structures can be assembled from carbon yarns, for example. Braided structures can include a hollow portion or a braided structure can be assembled about another core material.

In some embodiments a number of primary carbon fiber material structures can be organized into fabric or sheet-like structures. These include, for example, woven carbon fabrics, non-woven carbon fiber mat and carbon fiber ply, in addition to the tapes described above. Such higher ordered structures can be assembled from parent tows, yarns, filaments or the like, with CNTs already infused in the parent fiber. Alternatively such structures can serve as the substrate for the CNT infusion processes described herein.

There are three types of carbon fiber which are categorized based on the precursors used to generate the fibers, any of which can be used in the invention: Rayon, Polyacrylonitrile (PAN) and Pitch. Carbon fiber from rayon precursors, which are cellulosic materials, has relatively low carbon content at about 20% and the fibers tend to have low strength and stiffness. Polyacrylonitrile (PAN) precursors provide a carbon fiber with a carbon content of about 55%. Carbon fiber based on a PAN precursor generally has a higher tensile strength than carbon fiber based on other carbon fiber precursors due to a minimum of surface defects.

Pitch precursors based on petroleum asphalt, coal tar, and polyvinyl chloride can also be used to produce carbon fiber. Although pitches are relatively low in cost and high in carbon yield, there can be issues of non-uniformity in a given batch.

CNTs useful for infusion to carbon fiber materials include single-walled CNTs, double-walled CNTs, multi-walled CNTs, and mixtures thereof. The exact CNTs to be used depends on the application of the CNT-infused carbon fiber. CNTs can be used for thermal and/or electrical conductivity applications, or as insulators. In some embodiments, the infused carbon nanotubes are single-wall nanotubes. In some embodiments, the infused carbon nanotubes are multi-wall nanotubes. In some embodiments, the infused carbon nanotubes are a combination of single-wall and multi-wall nanotubes. There are some differences in the characteristic properties of single-wall and multi-wall nanotubes that, for some end uses of the fiber, dictate the synthesis of one or the other type of nanotube. For example, single-walled nanotubes can be semi-conducting or metallic, while multi-walled nanotubes are metallic.

CNTs lend their characteristic properties such as mechanical strength, low to moderate electrical resistivity, high thermal conductivity, and the like to the CNT-infused carbon fiber material. For example, in some embodiments, the electrical resistivity of a carbon nanotube-infused carbon fiber material is lower than the electrical resistivity of a parent carbon fiber material. More generally, the extent to which the resulting CNT-infused fiber expresses these characteristics can be a function of the extent and density of coverage of the carbon fiber by the carbon nanotubes. Any amount of the fiber surface area, from 0-55% of the fiber can be covered assuming an 8 nm diameter, 5-walled MWNT (again this calculation counts the space inside the CNTs as fillable). This number is lower for smaller diameter CNTs and more for greater diameter CNTs. 55% surface area coverage is equivalent to about 15,000 CNTs/micron2. Further CNT properties can be imparted to the carbon fiber material in a manner dependent on CNT length, as described above. Infused CNTs can vary in length ranging from between about 1 micron to about 500 microns, including 1 micron, 2 microns, 3 microns, 4 micron, 5, microns, 6, microns, 7 microns, 8 microns, 9 microns, 10 microns, 15 microns, 20 microns, 25 microns, 30 microns, 35 microns, 40 microns, 45 microns, 50 microns, 60 microns, 70 microns, 80 microns, 90 microns, 100 microns, 150 microns, 200 microns, 250 microns, 300 microns, 350 microns, 400 microns, 450 microns, 500 microns, and all values in between. CNTs can also be less than about 1 micron in length, including about 0.5 microns, for example. CNTs can also be greater than 500 microns, including for example, 510 microns, 520 microns, 550 microns, 600 microns, 700 microns and all values in between.

Compositions of the invention can incorporate CNTs have a length from about 0.1 micron to about 10 microns. Such CNT lengths can be useful in application to increase shear strength. CNTs can also have a length from about 5 to about 70 microns. Such CNT lengths can be useful in applications for increased tensile strength if the CNTs are aligned in the fiber direction. CNTs can also have a length from about 10 microns to about 100 microns. Such CNT lengths can be useful to increase electrical/thermal properties as well as mechanical properties. The process used in the invention can also provide CNTs having a length from about 100 microns to about 500 microns, which can also be beneficial to increase electrical and thermal properties. Such control of CNT length is readily achieved through modulation of carbon feedstock and inert gas flow rates coupled with varying linespeeds and growth temperature.

In some embodiments, compositions that include spoolable lengths of CNT-infused carbon fiber materials can have various uniform regions with different lengths of CNTs. For example, it can be desirable to have a first portion of CNT-infused carbon fiber material with uniformly shorter CNT lengths to enhance shear strength properties, and a second portion of the same spoolable material with a uniform longer CNT length to enhance electrical or thermal properties.

Processes of the invention for CNT infusion to carbon fiber materials allow control of the CNT lengths with uniformity and in a continuous process allowing spoolable carbon fiber materials to be functionalized with CNTs at high rates. With material residence times between 5 to 300 seconds, linespeeds in a continuous process for a system that is 3 feet long can be in a range anywhere from about 0.5 ft/min to about 36 ft/min and greater. The speed selected depends on various parameters as explained further below.

In some embodiments, a material residence time of about 5 to about 30 seconds can produce CNTs having a length between about 1 micron to about 10 microns. In some embodiments, a material residence time of about 30 to about 180 seconds can produce CNTs having a length between about 10 microns to about 100 microns. In still further embodiments, a material residence time of about 180 to about 300 seconds can produce CNTs having a length between about 100 microns to about 500 microns. One skilled in the art will recognize that these ranges are approximate and that CNT length can also be modulated by reaction temperatures, and carrier and carbon feedstock concentrations and flow rates.

CNT-infused carbon fiber materials of the invention include a barrier coating. Barrier coatings can include for example an alkoxysilane, methylsiloxane, an alumoxane, alumina nanoparticles, spin on glass and glass nanoparticles. As described below, the CNT-forming catalyst can be added to the uncured barrier coating material and then applied to the carbon fiber material together. In other embodiments the barrier coating material can be added to the carbon fiber material prior to deposition of the CNT-forming catalyst. The barrier coating material can be of a thickness sufficiently thin to allow exposure of the CNT-forming catalyst to the carbon feedstock for subsequent CVD growth. In some embodiments, the thickness is less than or about equal to the effective diameter of the CNT-forming catalyst. In some embodiments, the thickness of the barrier coating is in a range from between about 10 nm to about 100 nm. The barrier coating can also be less than 10 nm, including 1 nm, 2 nm, 3 nm, 4 nm, 5 nm, 6 nm, 7 nm, 8 nm, 9 nm, 10 nm, and any value in between.

Without being bound by theory, the barrier coating can serve as an intermediate layer between the carbon fiber material and the CNTs and serves to mechanically infuse the CNTs to the carbon fiber material. Such mechanical infusion still provides a robust system in which the carbon fiber material serves as a platform for organizing the CNTs while still imparting properties of the CNTs to the carbon fiber material. Moreover, the benefit of including a barrier coating is the immediate protection it provides the carbon fiber material from chemical damage due to exposure to moisture and/or any thermal damage due to heating of the carbon fiber material at the temperatures used to promote CNT growth.

The infused CNTs disclosed herein can effectively function as a replacement for conventional carbon fiber “sizing.” The infused CNTs are more robust than conventional sizing materials and can improve the fiber-to-matrix interface in composite materials and, more generally, improve fiber-to-fiber interfaces. Indeed, the CNT-infused carbon fiber materials disclosed herein are themselves composite materials in the sense the CNT-infused carbon fiber material properties will be a combination of those of the carbon fiber material as well as those of the infused CNTs. Consequently, embodiments of the present invention provide a means to impart desired properties to a carbon fiber material that otherwise lack such properties or possesses them in insufficient measure. Carbon fiber materials can be tailored or engineered to meet the requirements of specific applications. The CNTs acting as sizing can protect carbon fiber materials from absorbing moisture due to the hydrophobic CNT structure. Moreover, hydrophobic matrix materials, as further exemplified below, interact well with hydrophobic CNTs to provide improved fiber to matrix interactions.

Despite the beneficial properties imparted to a carbon fiber material having infused CNTs described above, the CNT-infused carbon fiber materials of the present invention can include further “conventional” sizing agents for storage prior to formation of an C/C composite structures. Such sizing agents vary widely in type and function and include, for example, surfactants, anti-static agents, lubricants, siloxanes, alkoxysilanes, aminosilanes, silanes, silanols, polyvinyl alcohol, starch, and mixtures thereof. Such secondary sizing agents can be used to protect the CNTs themselves or provide further properties to the fiber not imparted by the presence of the infused CNTs.

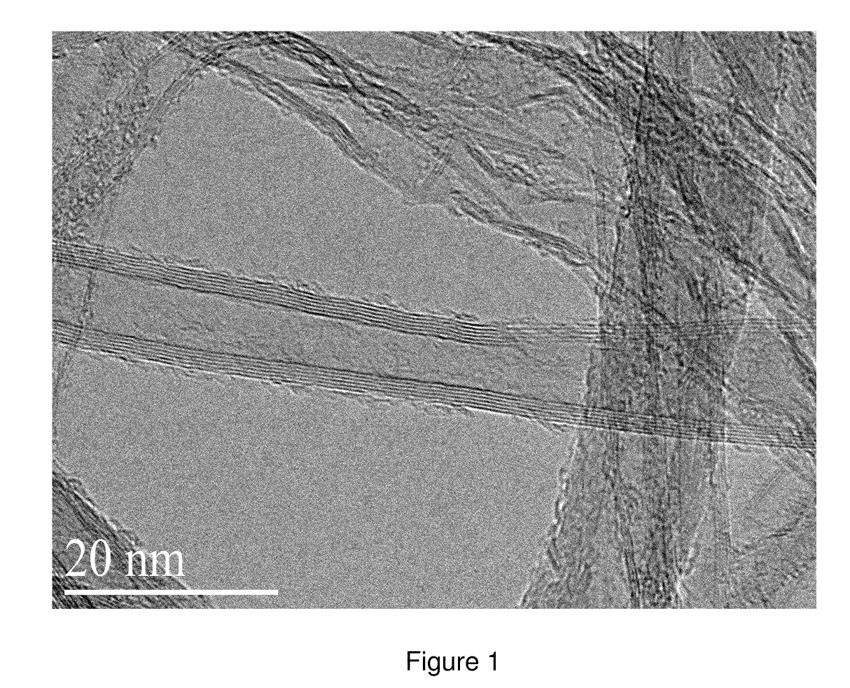

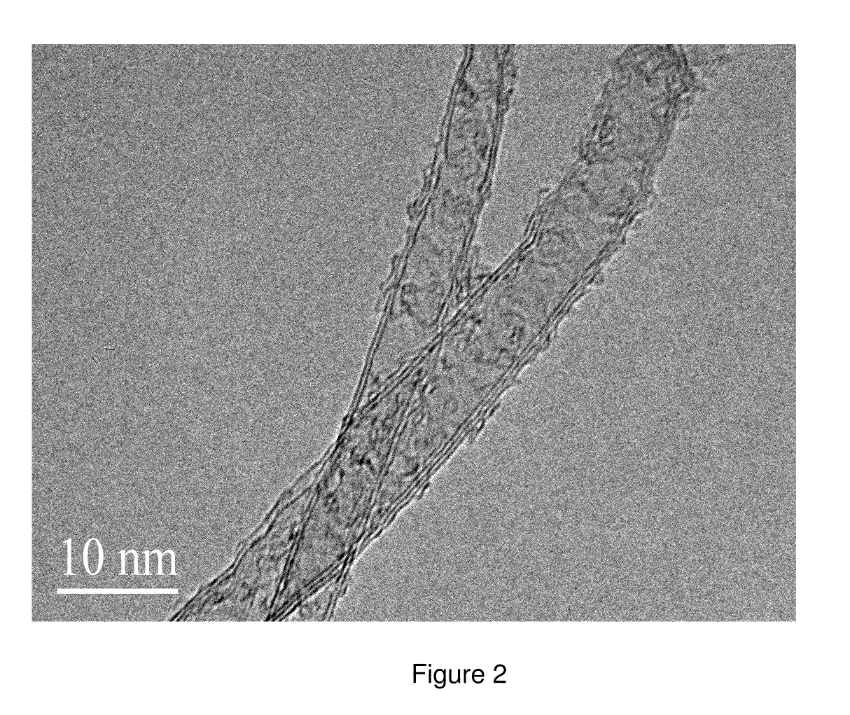

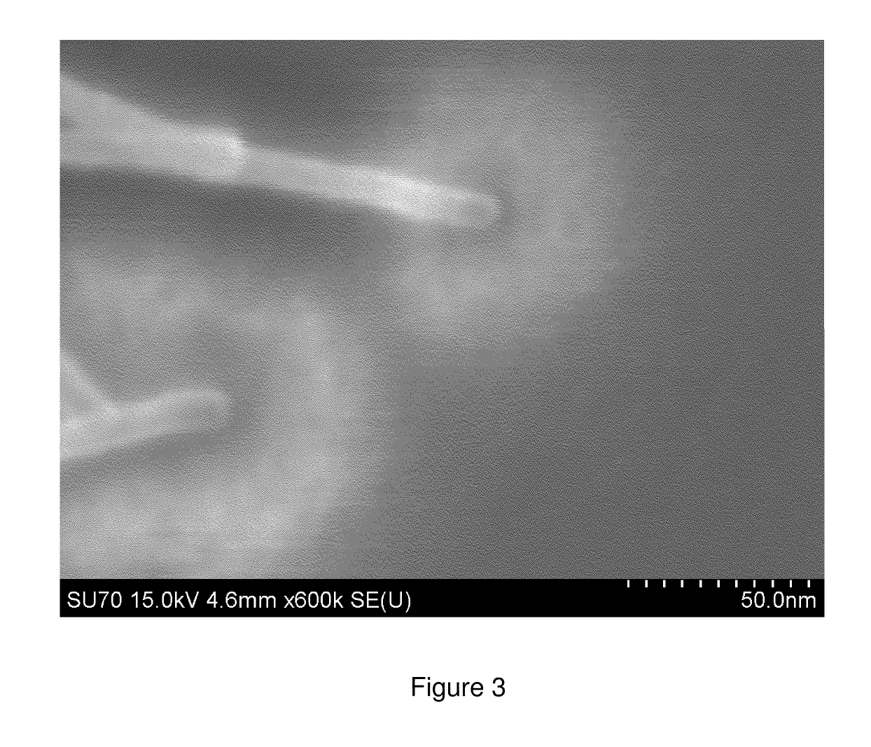

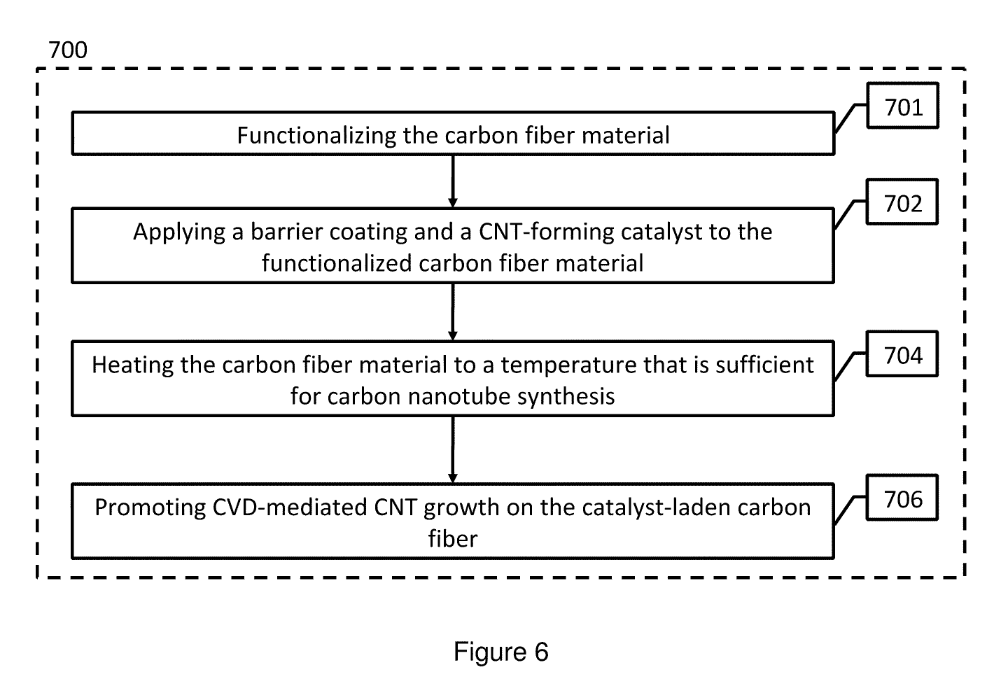

FIG. 1-6 shows TEM and SEM images of carbon fiber materials prepared by the processes described herein. The procedures for preparing these materials are further detailed below and in Examples I-III. FIGS. 1 and 2 show TEM images of multi-walled and double-walled carbon nanotubes, respectively, that were prepared on an AS4 carbon fiber in a continuous process. FIG. 3 shows a scanning electron microscope (SEM) image of CNTs growing from within the barrier coating after the CNT-forming nanoparticle catalyst was mechanically infused to a carbon fiber material surface. FIG. 4 shows a SEM image demonstrating the consistency in length distribution of CNTs grown on a carbon fiber material to within 20% of a targeted length of about 40 microns. FIG. 5 shows an SEM image demonstrating the effect of a barrier coating on CNT growth. Dense, well aligned CNTs grew where barrier coating was applied and no CNTs grew where barrier coating was absent. FIG. 6 shows a low magnification SEM of CNTs on carbon fiber demonstrating the uniformity of CNT density across the fibers within about 10%.

CNT infused carbon fiber materials in C/C composites can be used in applications requiring wear-resistance. Such carbon fiber friction materials are used in, for example, automotive brake discs. Other wear resistance applications can include, for example, rubber o-rings and gasket seals.

CNT-infused carbon fiber materials in C/C composites can enhance structural elements in aerospace and ballistics applications. For example, the structures such as nose cones in missiles, leading edge of wings, primary structural parts, such as flaps and aerofoils, propellers and air brakes, small plane fuselages, helicopter shells and rotor blades, aircraft secondary structural parts, such as floors, doors, seats, air conditioners, and secondary tanks and airplane motor parts can benefit from the structural enhancement provided by CNT-infused carbon fibers. Structural enhancement in many other applications can include, for example, mine sweeper hulls, helmets, radomes, rocket nozzles, rescue stretchers, and engine components. In building and construction, structural enhancement of exterior features include columns, pediments, domes, cornices, and formwork. Likewise, in interior building structures such as blinds, sanitary-ware, window profiles, and the like can all benefit from the use of CNT-infused carbon fiber materials in C/C composites.

The electrical properties of CNT-infused carbon fibers also can impact various energy and electrical applications. For example, CNT-infused carbon fiber materials in C/C composites can be used in wind turbine blades, solar structures, electronic enclosures, such as laptops, cell phones, computer cabinets, where such CNT-infused materials can be used in EMI shielding, for example. Other applications include powerlines, cooling devices, light poles, circuit boards, electrical junction boxes, ladder rails, optical fiber, power built into structures such as data lines, computer terminal housings, and business equipment, such as copiers, cash registers and mailing equipment.

In some embodiments the present invention provides a continuous process for CNT infusion that includes (a) disposing a carbon nanotube-forming catalyst on a surface of a carbon fiber material of spoolable dimensions; and (b) synthesizing carbon nanotubes directly on the carbon fiber material, thereby forming a carbon nanotube-infused carbon fiber material. For a 9 foot long system, the linespeed of the process can range from between about 1.5 ft/min to about 108 ft/min. The linespeeds achieved by the process described herein allow the formation of commercially relevant quantities of CNT-infused carbon fiber materials with short production times. For example, at 36 ft/min linespeed, the quantities of CNT-infused carbon fibers (over 5% infused CNTs on fiber by weight) can exceed over 100 pounds or more of material produced per day in a system that is designed to simultaneously process 5 separate tows (20 lb/tow). Systems can be made to produce more tows at once or at faster speeds by repeating growth zones. Moreover, some steps in the fabrication of CNTs, as known in the art, have prohibitively slow rates preventing a continuous mode of operation. For example, in a typical process known in the art, a CNT-forming catalyst reduction step can take 1-12 hours to perform. CNT growth itself can also be time consuming, for example requiring tens of minutes for CNT growth, precluding the rapid linespeeds realized in the present invention. The process described herein overcomes such rate limiting steps.

The CNT-infused carbon fiber material-forming processes of the invention can avoid CNT entanglement that occurs when trying to apply suspensions of pre-formed carbon nanotubes to fiber materials. That is, because pre-formed CNTs are not fused to the carbon fiber material, the CNTs tend to bundle and entangle. The result is a poorly uniform distribution of CNTs that weakly adhere to the carbon fiber material. However, processes of the present invention can provide, if desired, a highly uniform entangled CNT mat on the surface of the carbon fiber material by reducing the growth density. The CNTs grown at low density are infused in the carbon fiber material first. In such embodiments, the fibers do not grow dense enough to induce vertical alignment, the result is entangled mats on the carbon fiber material surfaces. By contrast, manual application of pre-formed CNTs does not insure uniform distribution and density of a CNT mat on the carbon fiber material.

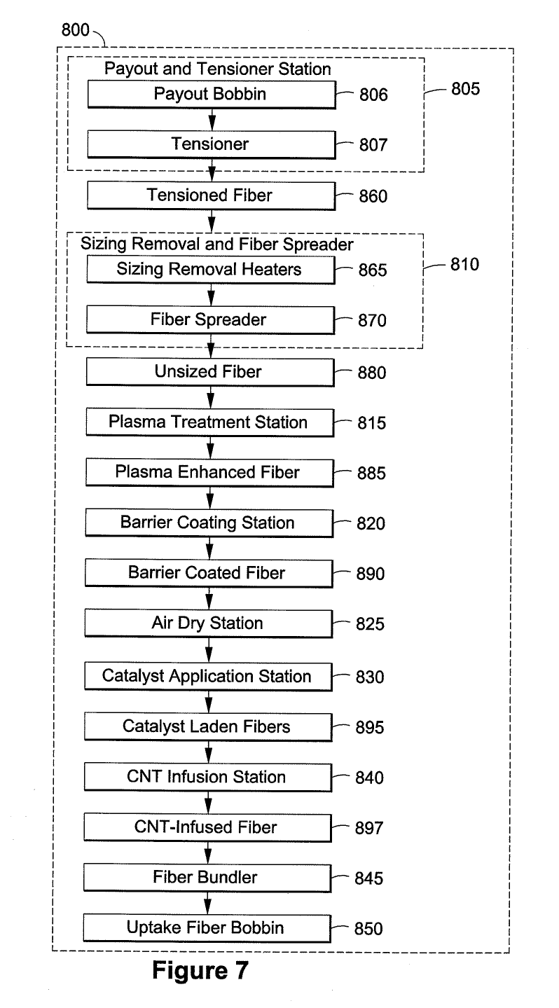

FIG. 7 depicts a flow diagram of process 700 for producing CNT-infused carbon fiber material in accordance with an illustrative embodiment of the present invention.

Process 700 includes at least the operations of:
701: Functionalizing the carbon fiber material.
702: Applying a barrier coating and a CNT-forming catalyst to the functionalized carbon fiber material.
704: Heating the carbon fiber material to a temperature that is sufficient for carbon nanotube synthesis.
706: Promoting CVD-mediated CNT growth on the catalyst-laden carbon fiber.

In step 701, the carbon fiber material is functionalized to promote surface wetting of the fibers and to improve adhesion of the barrier coating.

To infuse carbon nanotubes into a carbon fiber material, the carbon nanotubes are synthesized on the carbon fiber material which is conformally coated with a barrier coating. In one embodiment, this is accomplished by first conformally coating the carbon fiber material with a barrier coating and then disposing nanotube-forming catalyst on the barrier coating, as per operation 702. In some embodiments, the barrier coating can be partially cured prior to catalyst deposition. This can provide a surface that is receptive to receiving the catalyst and allowing it to embed in the barrier coating, including allowing surface contact between the CNT forming catalyst and the carbon fiber material. In such embodiments, the barrier coating can be fully cured after embedding the catalyst. In some embodiments, the barrier coating is conformally coated over the carbon fiber material simultaneously with deposition of the CNT-form catalyst. Once the CNT-forming catalyst and barrier coating are in place, the barrier coating can be fully cured.

In some embodiments, the barrier coating can be fully cured prior to catalyst deposition. In such embodiments, a fully cured barrier-coated carbon fiber material can be treated with a plasma to prepare the surface to accept the catalyst. For example, a plasma treated carbon fiber material having a cured barrier coating can provide a roughened surface in which the CNT-forming catalyst can be deposited. The plasma process for “roughing” the surface of the barrier thus facilitates catalyst deposition. The roughness is typically on the scale of nanometers. In the plasma treatment process craters or depressions are formed that are nanometers deep and nanometers in diameter. Such surface modification can be achieved using a plasma of any one or more of a variety of different gases, including, without limitation, argon, helium, oxygen, nitrogen, and hydrogen. In some embodiments, plasma roughing can also be performed directly in the carbon fiber material itself. This can facilitate adhesion of the barrier coating to the carbon fiber material.

As described further below and in conjunction with FIG. 7, the catalyst is prepared as a liquid solution that contains CNT-forming catalyst that comprise transition metal nanoparticles. The diameters of the synthesized nanotubes are related to the size of the metal particles as described above. In some embodiments, commercial dispersions of CNT-forming transition metal nanoparticle catalyst are available and are used without dilution, in other embodiments commercial dispersions of catalyst can be diluted. Whether to dilute such solutions can depend on the desired density and length of CNT to be grown as described above.

With reference to the illustrative embodiment of FIG. 7, carbon nanotube synthesis is shown based on a chemical vapor deposition (CVD) process and occurs at elevated temperatures. The specific temperature is a function of catalyst choice, but will typically be in a range of about 500 to 1000° C. Accordingly, operation 704 involves heating the barrier-coated carbon fiber material to a temperature in the aforementioned range to support carbon nanotube synthesis.

In operation 706, CVD-promoted nanotube growth on the catalyst-laden carbon fiber material is then performed. The CVD process can be promoted by, for example, a carbon-containing feedstock gas such as acetylene, ethylene, and/or ethanol. The CNT synthesis processes generally use an inert gas (nitrogen, argon, helium) as a primary carrier gas. The carbon feedstock is provided in a range from between about 0% to about 15% of the total mixture. A substantially inert environment for CVD growth is prepared by removal of moisture and oxygen from the growth chamber.

In the CNT synthesis process, CNTs grow at the sites of a CNT-forming transition metal nanoparticle catalyst. The presence of the strong plasma-creating electric field can be optionally employed to affect nanotube growth. That is, the growth tends to follow the direction of the electric field. By properly adjusting the geometry of the plasma spray and electric field, vertically-aligned CNTs (i.e., perpendicular to the carbon fiber material) can be synthesized. Under certain conditions, even in the absence of a plasma, closely-spaced nanotubes will maintain a vertical growth direction resulting in a dense array of CNTs resembling a carpet or forest. The presence of the barrier coating can also influence the directionality of CNT growth.

The operation of disposing a catalyst on the carbon fiber material can be accomplished by spraying or dip coating a solution or by gas phase deposition via, for example, a plasma process. The choice of techniques can be coordinated with the mode with which the barrier coating is applied. Thus, in some embodiments, after forming a solution of a catalyst in a solvent, catalyst can be applied by spraying or dip coating the barrier coated carbon fiber material with the solution, or combinations of spraying and dip coating. Either technique, used alone or in combination, can be employed once, twice, thrice, four times, up to any number of times to provide a carbon fiber material that is sufficiently uniformly coated with CNT-forming catalyst. When dip coating is employed, for example, a carbon fiber material can be placed in a first dip bath for a first residence time in the first dip bath. When employing a second dip bath, the carbon fiber material can be placed in the second dip bath for a second residence time. For example, carbon fiber materials can be subjected to a solution of CNT-forming catalyst for between about 3 seconds to about 90 seconds depending on the dip configuration and linespeed. Employing spraying or dip coating processes, a carbon fiber material with a surface density of catalyst of less than about 5% surface coverage to as high as about 80% coverage, in which the CNT-forming catalyst nanoparticles are nearly monolayer. In some embodiments, the process of coating the CNT-forming catalyst on the carbon fiber material should produce no more than a monolayer. For example, CNT growth on a stack of CNT-forming catalyst can erode the degree of infusion of the CNT to the carbon fiber material. In other embodiments, the transition metal catalyst can be deposited on the carbon fiber material using evaporation techniques, electrolytic deposition techniques, and other processes known to those skilled in the art, such as addition of the transition metal catalyst to a plasma feedstock gas as a metal organic, metal salt or other composition promoting gas phase transport.

Because processes of the invention are designed to be continuous, a spoolable carbon fiber material can be dip-coated in a series of baths where dip coating baths are spatially separated. In a continuous process in which nascent carbon fibers are being generated de novo, dip bath or spraying of CNT-forming catalyst can be the first step after applying and curing or partially curing a barrier coating to the carbon fiber material. Application of the barrier coating and a CNT-forming catalyst can be performed in lieu of application of a sizing, for newly formed carbon fiber materials. In other embodiments, the CNT-forming catalyst can be applied to newly formed carbon fibers in the presence of other sizing agents after barrier coating. Such simultaneous application of CNT-forming catalyst and other sizing agents can still provide the CNT-forming catalyst in surface contact with the barrier coating of the carbon fiber material to insure CNT infusion.

The catalyst solution employed can be a transition metal nanoparticle which can be any d-block transition metal as described above. In addition, the nanoparticles can include alloys and non-alloy mixtures of d-block metals in elemental form or in salt form, and mixtures thereof. Such salt forms include, without limitation, oxides, carbides, and nitrides. Non-limiting exemplary transition metal NPs include Ni, Fe, Co, Mo, Cu, Pt, Au, and Ag and salts thereof and mixtures thereof. In some embodiments, such CNT-forming catalysts are disposed on the carbon fiber by applying or infusing a CNT-forming catalyst directly to the carbon fiber material simultaneously with barrier coating deposition. Many of these transition metal catalysts are readily commercially available from a variety of suppliers, including, for example, Ferrotec Corporation (Bedford, N.H.).

Catalyst solutions used for applying the CNT-forming catalyst to the carbon fiber material can be in any common solvent that allows the CNT-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the CNT-forming catalyst nanoparticles. Concentrations of CNT-forming catalyst can be in a range from about 1:1 to 1:10000 catalyst to solvent. Such concentrations can be used when the barrier coating and CNT-forming catalyst is applied simultaneously as well.

In some embodiments heating of the carbon fiber material can be at a temperature that is between about 500° C. and 1000° C. to synthesize carbon nanotubes after deposition of the CNT-forming catalyst. Heating at these temperatures can be performed prior to or substantially simultaneously with introduction of a carbon feedstock for CNT growth.

In some embodiments, the present invention provides a process that includes removing sizing agents from a carbon fiber material, applying a barrier coating conformally over the carbon fiber material, applying a CNT-forming catalyst to the carbon fiber material, heating the carbon fiber material to at least 500° C., and synthesizing carbon nanotubes on the carbon fiber material. In some embodiments, operations of the CNT-infusion process include removing sizing from a carbon fiber material, applying a barrier coating to the carbon fiber material, applying a CNT-forming catalyst to the carbon fiber, heating the fiber to CNT-synthesis temperature and CVD-promoted CNT growth the catalyst-laden carbon fiber material. Thus, where commercial carbon fiber materials are employed, processes for constructing CNT-infused carbon fibers can include a discrete step of removing sizing from the carbon fiber material before disposing barrier coating and the catalyst on the carbon fiber material.

The step of synthesizing carbon nanotubes can include numerous techniques for forming carbon nanotubes, including those disclosed in co-pending U.S. Patent Application No. US 2004/0245088 which is incorporated herein by reference. The CNTs grown on fibers of the present invention can be accomplished by techniques known in the art including, without limitation, micro-cavity, thermal or plasma-enhanced CVD techniques, laser ablation, arc discharge, and high pressure carbon monoxide (HiPCO). During CVD, in particular, a barrier coated carbon fiber material with CNT-forming catalyst disposed thereon, can be used directly. In some embodiments, any conventional sizing agents can be removed prior CNT synthesis. In some embodiments, acetylene gas is ionized to create a jet of cold carbon plasma for CNT synthesis. The plasma is directed toward the catalyst-bearing carbon fiber material. Thus, in some embodiments synthesizing CNTs on a carbon fiber material includes (a) forming a carbon plasma; and (b) directing the carbon plasma onto the catalyst disposed on the carbon fiber material. The diameters of the CNTs that are grown are dictated by the size of the CNT-forming catalyst as described above. In some embodiments, the sized fiber substrate is heated to between about 550 to about 800° C. to facilitate CNT synthesis. To initiate the growth of CNTs, two gases are bled into the reactor: a process gas such as argon, helium, or nitrogen, and a carbon-containing gas, such as acetylene, ethylene, ethanol or methane. CNTs grow at the sites of the CNT-forming catalyst.

In some embodiments, the CVD growth is plasma-enhanced. A plasma can be generated by providing an electric field during the growth process. CNTs grown under these conditions can follow the direction of the electric field. Thus, by adjusting the geometry of the reactor vertically aligned carbon nanotubes can be grown radially about a cylindrical fiber. In some embodiments, a plasma is not required for radial growth about the fiber. For carbon fiber materials that have distinct sides such as tapes, mats, fabrics, plies, and the like, catalyst can be disposed on one or both sides and correspondingly, CNTs can be grown on one or both sides as well.

As described above, CNT-synthesis is performed at a rate sufficient to provide a continuous process for functionalizing spoolable carbon fiber materials. Numerous apparatus configurations facilitate such continuous synthesis as exemplified below.

In some embodiments, CNT-infused carbon fiber materials can be constructed in an “all plasma” process. An all plasma process can being with roughing the carbon fiber material with a plasma as described above to improve fiber surface wetting characteristics and provide a more conformal barrier coating, as well as improve coating adhesion via mechanical interlocking and chemical adhesion through the use of functionalization of the carbon fiber material by using specific reactive gas species, such as oxygen, nitrogen, hydrogen in argon or helium based plasmas.

Barrier coated carbon fiber materials pass through numerous further plasma-mediated steps to form the final CNT-infused product. In some embodiments, the all plasma process can include a second surface modification after the barrier coating is cured. This is a plasma process for “roughing” the surface of the barrier coating on the carbon fiber material to facilitate catalyst deposition. As described above, surface modification can be achieved using a plasma of any one or more of a variety of different gases, including, without limitation, argon, helium, oxygen, ammonia, hydrogen, and nitrogen.

After surface modification, the barrier coated carbon fiber material proceeds to catalyst application. This is a plasma process for depositing the CNT-forming catalyst on the fibers. The CNT-forming catalyst is typically a transition metal as described above. The transition metal catalyst can be added to a plasma feedstock gas as a precursor in the form of a ferrofluid, a metal organic, metal salt or other composition for promoting gas phase transport. The catalyst can be applied at room temperature in the ambient environment with neither vacuum nor an inert atmosphere being required. In some embodiments, the carbon fiber material is cooled prior to catalyst application.

Continuing the all-plasma process, carbon nanotube synthesis occurs in a CNT-growth reactor. This can be achieved through the use of plasma-enhanced chemical vapor deposition, wherein carbon plasma is sprayed onto the catalyst-laden fibers. Since carbon nanotube growth occurs at elevated temperatures (typically in a range of about 500 to 1000° C. depending on the catalyst), the catalyst-laden fibers can be heated prior to exposing to the carbon plasma. For the infusion process, the carbon fiber material can be optionally heated until it softens. After heating, the carbon fiber material is ready to receive the carbon plasma. The carbon plasma is generated, for example, by passing a carbon containing gas such as acetylene, ethylene, ethanol, and the like, through an electric field that is capable of ionizing the gas. This cold carbon plasma is directed, via spray nozzles, to the carbon fiber material. The carbon fiber material can be in close proximity to the spray nozzles, such as within about 1 centimeter of the spray nozzles, to receive the plasma. In some embodiments, heaters are disposed above the carbon fiber material at the plasma sprayers to maintain the elevated temperature of the carbon fiber material.

Another configuration for continuous carbon nanotube synthesis involves a special rectangular reactor for the synthesis and growth of carbon nanotubes directly on carbon fiber materials. The reactor can be designed for use in a continuous in-line process for producing carbon-nanotube bearing fibers. In some embodiments, CNTs are grown via a chemical vapor deposition (“CVD”) process at atmospheric pressure and at elevated temperature in the range of about 550° C. to about 800° C. in a multi-zone reactor. The fact that the synthesis occurs at atmospheric pressure is one factor that facilitates the incorporation of the reactor into a continuous processing line for CNT-on-fiber synthesis. Another advantage consistent with in-line continuous processing using such a zone reactor is that CNT growth occurs in a seconds, as opposed to minutes (or longer) as in other procedures and apparatus configurations typical in the art.

CNT synthesis reactors in accordance with the various embodiments include the following features:

Rectangular Configured Synthesis Reactors: The cross section of a typical CNT synthesis reactor known in the art is circular. There are a number of reasons for this including, for example, historical reasons (cylindrical reactors are often used in laboratories) and convenience (flow dynamics are easy to model in cylindrical reactors, heater systems readily accept circular tubes (quartz, etc.), and ease of manufacturing. Departing from the cylindrical convention, the present invention provides a CNT synthesis reactor having a rectangular cross section. The reasons for the departure are as follows: 1. Since many carbon fiber materials that can be processed by the reactor are relatively planar such as flat tape or sheet-like in form, a circular cross section is an inefficient use of the reactor volume. This inefficiency results in several drawbacks for cylindrical CNT synthesis reactors including, for example, a) maintaining a sufficient system purge; increased reactor volume requires increased gas flow rates to maintain the same level of gas purge. This results in a system that is inefficient for high volume production of CNTs in an open environment; b) increased carbon feedstock gas flow; the relative increase in inert gas flow, as per a) above, requires increased carbon feedstock gas flows. Consider that the volume of a 12K carbon fiber tow is 2000 times less than the total volume of a synthesis reactor having a rectangular cross section. In an equivalent growth cylindrical reactor (i.e., a cylindrical reactor that has a width that accommodates the same planarized carbon fiber material as the rectangular cross-section reactor), the volume of the carbon fiber material is 17,500 times less than the volume of the chamber. Although gas deposition processes, such as CVD, are typically governed by pressure and temperature alone, volume has a significant impact on the efficiency of deposition. With a rectangular reactor there is a still excess volume. This excess volume facilitates unwanted reactions; yet a cylindrical reactor has about eight times that volume. Due to this greater opportunity for competing reactions to occur, the desired reactions effectively occur more slowly in a cylindrical reactor chamber. Such a slow down in CNT growth, is problematic for the development of a continuous process. One benefit of a rectangular reactor configuration is that the reactor volume can be decreased by using a small height for the rectangular chamber to make this volume ratio better and reactions more efficient. In some embodiments of the present invention, the total volume of a rectangular synthesis reactor is no more than about 3000 times greater than the total volume of a carbon fiber material being passed through the synthesis reactor. In some further embodiments, the total volume of the rectangular synthesis reactor is no more than about 4000 times greater than the total volume of the carbon fiber material being passed through the synthesis reactor. In some still further embodiments, the total volume of the rectangular synthesis reactor is less than about 10,000 times greater than the total volume of the carbon fiber material being passed through the synthesis reactor. Additionally, it is notable that when using a cylindrical reactor, more carbon feedstock gas is required to provide the same flow percent as compared to reactors having a rectangular cross section. It should be appreciated that in some other embodiments, the synthesis reactor has a cross section that is described by polygonal forms that are not rectangular, but are relatively similar thereto and provide a similar reduction in reactor volume relative to a reactor having a circular cross section; c) problematic temperature distribution; when a relatively small-diameter reactor is used, the temperature gradient from the center of the chamber to the walls thereof is minimal. But with increased size, such as would be used for commercial-scale production, the temperature gradient increases. Such temperature gradients result in product quality variations across a carbon fiber material substrate (i.e., product quality varies as a function of radial position). This problem is substantially avoided when using a reactor having a rectangular cross section. In particular, when a planar substrate is used, reactor height can be maintained constant as the size of the substrate scales upward. Temperature gradients between the top and bottom of the reactor are essentially negligible and, as a consequence, thermal issues and the product-quality variations that result are avoided. 2. Gas introduction: Because tubular furnaces are normally employed in the art, typical CNT synthesis reactors introduce gas at one end and draw it through the reactor to the other end. In some embodiments disclosed herein, gas can be introduced at the center of the reactor or within a target growth zone, symmetrically, either through the sides or through the top and bottom plates of the reactor. This improves the overall CNT growth rate because the incoming feedstock gas is continuously replenishing at the hottest portion of the system, which is where CNT growth is most active. This constant gas replenishment is an important aspect to the increased growth rate exhibited by the rectangular CNT reactors.

Zoning. Chambers that provide a relatively cool purge zone depend from both ends of the rectangular synthesis reactor. Applicants have determined that if hot gas were to mix with the external environment (i.e., outside of the reactor), there would be an increase in degradation of the carbon fiber material. The cool purge zones provide a buffer between the internal system and external environments. Typical CNT synthesis reactor configurations known in the art typically require that the substrate is carefully (and slowly) cooled. The cool purge zone at the exit of the present rectangular CNT growth reactor achieves the cooling in a short period of time, as required for the continuous in-line processing.

Non-contact, hot-walled, metallic reactor. In some embodiments, a hot-walled reactor is made of metal is employed, in particular stainless steel. This may appear counterintuitive because metal, and stainless steel in particular, is more susceptible to carbon deposition (i.e., soot and by-product formation). Thus, most CNT reactor configurations use quartz reactors because there is less carbon deposited, quartz is easier to clean, and quartz facilitates sample observation. However, Applicants have observed that the increased soot and carbon deposition on stainless steel results in more consistent, faster, more efficient, and more stable CNT growth. Without being bound by theory it has been indicated that, in conjunction with atmospheric operation, the CVD process occurring in the reactor is diffusion limited. That is, the catalyst is “overfed;” too much carbon is available in the reactor system due to its relatively higher partial pressure (than if the reactor was operating under partial vacuum). As a consequence, in an open system—especially a clean one—too much carbon can adhere to catalyst particles, compromising their ability to synthesize CNTs. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, react with the catalyst at a rate that does not poison the catalyst. Existing systems run “cleanly” which, if they were open for continuous processing, would produced a much lower yield of CNTs at reduced growth rates.

Although it is generally beneficial to perform CNT synthesis “dirty” as described above, certain portions of the apparatus, such as gas manifolds and inlets, can nonetheless negatively impact the CNT growth process when soot created blockages. In order to combat this problem, such areas of the CNT growth reaction chamber can be protected with soot inhibiting coatings such as silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones.

Combined Catalyst Reduction and CNT Synthesis. In the CNT synthesis reactor disclosed herein, both catalyst reduction and CNT growth occur within the reactor. This is significant because the reduction step cannot be accomplished timely enough for use in a continuous process if performed as a discrete operation. In a typical process known in the art, a reduction step typically takes 1-12 hours to perform. Both operations occur in a reactor in accordance with the present invention due, at least in part, to the fact that carbon feedstock gas is introduced at the center of the reactor, not the end as would be typical in the art using cylindrical reactors. The reduction process occurs as the fibers enter the heated zone; by this point, the gas has had time to react with the walls and cool off prior to reacting with the catalyst and causing the oxidation reduction (via hydrogen radical interactions). It is this transition region where the reduction occurs. At the hottest isothermal zone in the system, the CNT growth occurs, with the greatest growth rate occurring proximal to the gas inlets near the center of the reactor.

In some embodiments, when loosely affiliated carbon fiber materials, such as carbon tow are employed, the continuous process can include steps that spreads out the strands and/or filaments of the tow. Thus, as a tow is unspooled it can be spread using a vacuum-based fiber spreading system, for example. When employing sized carbon fibers, which can be relatively stiff, additional heating can be employed in order to “soften” the tow to facilitate fiber spreading. The spread fibers which comprise individual filaments can be spread apart sufficiently to expose an entire surface area of the filaments, thus allowing the tow to more efficiently react in subsequent process steps. Such spreading can approach between about 4 inches to about 6 inches across for a 3 k tow. The spread carbon tow can pass through a surface treatment step that is composed of a plasma system as described above. After a barrier coating is applied and roughened, spread fibers then can pass through a CNT-forming catalyst dip bath. The result is fibers of the carbon tow that have catalyst particles distributed radially on their surface. The catalyzed-laden fibers of the tow then enter an appropriate CNT growth chamber, such as the rectangular chamber described above, where a flow through atmospheric pressure CVD or PE-CVD process is used to synthesize the CNTs at rates as high as several microns per second. The fibers of the tow, now with radially aligned CNTs, exit the CNT growth reactor.

In some embodiments, CNT-infused carbon fiber materials can pass through yet another treatment process that, in some embodiments is a plasma process used to functionalize the CNTs. Additional functionalization of CNTs can be used to promote their adhesion to particular resins. Thus, in some embodiments, the present invention provides CNT-infused carbon fiber materials having functionalized CNTs.

As part of the continuous processing of spoolable carbon fiber materials, the a CNT-infused carbon fiber material can further pass through a sizing dip bath to apply any additional sizing agents which can be beneficial in a final product. Finally if wet winding is desired, the CNT-infused carbon fiber materials can be passed through a resin bath and wound on a mandrel or spool. The resulting carbon fiber material/resin combination locks the CNTs on the carbon fiber material allowing for easier handling and composite fabrication. In some embodiments, CNT infusion is used to provide improved filament winding. Thus, CNTs formed on carbon fibers such as carbon tow, are passed through a resin bath to produce resin-impregnated, CNT-infused carbon tow. After resin impregnation, the carbon tow can be positioned on the surface of a rotating mandrel by a delivery head. The tow can then be wound onto the mandrel in a precise geometric pattern in known fashion.

The winding process described above provides pipes, tubes, or other forms as are characteristically produced via a male mold. But the forms made from the winding process disclosed herein differ from those produced via conventional filament winding processes. Specifically, in the process disclosed herein, the forms are made from composite materials that include CNT-infused tow. Such forms will therefore benefit from enhanced strength and the like, as provided by the CNT-infused tow.

In some embodiments, a continuous process for infusion of CNTs on spoolable carbon fiber materials can achieve a linespeed between about 0.5 ft/min to about 36 ft/min. In this embodiment where the CNT growth chamber is 3 feet long and operating at a 750° C. growth temperature, the process can be run with a linespeed of about 6 ft/min to about 36 ft/min to produce, for example, CNTs having a length between about 1 micron to about 10 microns. The process can also be run with a linespeed of about 1 ft/min to about 6 ft/min to produce, for example, CNTs having a length between about 10 microns to about 100 microns. The process can be run with a linespeed of about 0.5 ft/min to about 1 ft/min to produce, for example, CNTs having a length between about 100 microns to about 200 microns. The CNT length is not tied only to linespeed and growth temperature, however, the flow rate of both the carbon feedstock and the inert carrier gases can also influence CNT length. For example, a flow rate consisting of less than 1% carbon feedstock in inert gas at high linespeeds (6 ft/min to 36 ft/min) will result in CNTs having a length between 1 micron to about 5 microns. A flow rate consisting of more than 1% carbon feedstock in inert gas at high linespeeds (6 ft/min to 36 ft/min) will result in CNTs having length between 5 microns to about 10 microns.

In some embodiments, more than one carbon material can be run simultaneously through the process. For example, multiple tapes tows, filaments, strand and the like can be run through the process in parallel. Thus, any number of pre-fabricated spools of carbon fiber material can be run in parallel through the process and re-spooled at the end of the process. The number of spooled carbon fiber materials that can be run in parallel can include one, two, three, four, five, six, up to any number that can be accommodated by the width of the CNT-growth reaction chamber. Moreover, when multiple carbon fiber materials are run through the process, the number of collection spools can be less than the number of spools at the start of the process. In such embodiments, carbon strands, tows, or the like can be sent through a further process of combining such carbon fiber materials into higher ordered carbon fiber materials such as woven fabrics or the like. The continuous process can also incorporate a post processing chopper that facilitates the formation CNT-infused chopped fiber mats, for example.

In some embodiments, processes of the invention allow for synthesizing a first amount of a first type of carbon nanotube on the carbon fiber material, in which the first type of carbon nanotube is selected to alter at least one first property of the carbon fiber material. Subsequently, process of the invention allow for synthesizing a second amount of a second type of carbon nanotube on the carbon fiber material, in which the second type of carbon nanotube is selected to alter at least one second property of the carbon fiber material.

In some embodiments, the first amount and second amount of CNTs are different. This can be accompanied by a change in the CNT type or not. Thus, varying the density of CNTs can be used to alter the properties of the original carbon fiber material, even if the CNT type remains unchanged. CNT type can include CNT length and the number of walls, for example. In some embodiments the first amount and the second amount are the same. If different properties are desirable in this case along the two different stretches of the spoolable material, then the CNT type can be changed, such as the CNT length. For example, longer CNTs can be useful in electrical/thermal applications, while shorter CNTs can be useful in mechanical strengthening applications.

In light of the aforementioned discussion regarding altering the properties of the carbon fiber materials, the first type of carbon nanotube and the second type of carbon nanotube can be the same, in some embodiments, while the first type of carbon nanotube and the second type of carbon nanotube can be different, in other embodiments Likewise, the first property and the second property can be the same, in some embodiments. For example, the EMI shielding property can be the property of interest addressed by the first amount and type of CNTs and the 2nd amount and type of CNTs, but the degree of change in this property can be different, as reflected by differing amounts, and/or types of CNTs employed. Finally, in some embodiments, the first property and the second property can be different. Again this may reflect a change in CNT type. For example the first property can be mechanical strength with shorter CNTs, while the second property can be electrical/thermal properties with longer CNTs. One skilled in the art will recognize the ability to tailor the properties of the carbon fiber material through the use of different CNT densities, CNT lengths, and the number of walls in the CNTs, such as single-walled, double-walled, and multi-walled, for example.

In some embodiments, processes of the present invention provides synthesizing a first amount of carbon nanotubes on a carbon fiber material, such that this first amount allows the carbon nanotube-infused carbon fiber material to exhibit a second group of properties that differ from a first group of properties exhibited by the carbon fiber material itself. That is, selecting an amount that can alter one or more properties of the carbon fiber material, such as tensile strength. The first group of properties and second group of properties can include at least one of the same properties, thus representing enhancing an already existing property of the carbon fiber material. In some embodiments, CNT infusion can impart a second group of properties to the carbon nanotube-infused carbon fiber material that is not included among the first group of properties exhibited by the carbon fiber material itself.

In some embodiments, a first amount of carbon nanotubes is selected such that the value of at least one property selected from the group consisting of tensile strength, Young's Modulus, shear strength, shear modulus, toughness, compression strength, compression modulus, density, EM wave absorptivity/reflectivity, acoustic transmittance, electrical conductivity, and thermal conductivity of the carbon nanotube-infused carbon fiber material differs from the value of the same property of the carbon fiber material itself.

The CNT-infused carbon fiber materials can benefit from the presence of CNTs not only in the properties described above, but can also provide lighter materials in the process. Thus, such lower density and higher strength materials translates to greater strength to weight ratio.

It is understood that modifications which do not substantially affect the activity of the various embodiments of this invention are also included within the definition of the invention provided herein. Accordingly, the following examples are intended to illustrate but not limit the present invention.

### Example I

This example shows how a carbon fiber material can be infused with CNTs in a continuous process to target thermal and electrical conductivity improvements.

In this example, the maximum loading of CNTs on fibers is targeted. 34-700 12 k carbon fiber tow with a tex value of 800 (Grafil Inc., Sacramento, Calif.) is implemented as the carbon fiber substrate. The individual filaments in this carbon fiber tow have a diameter of approximately 7 μm.

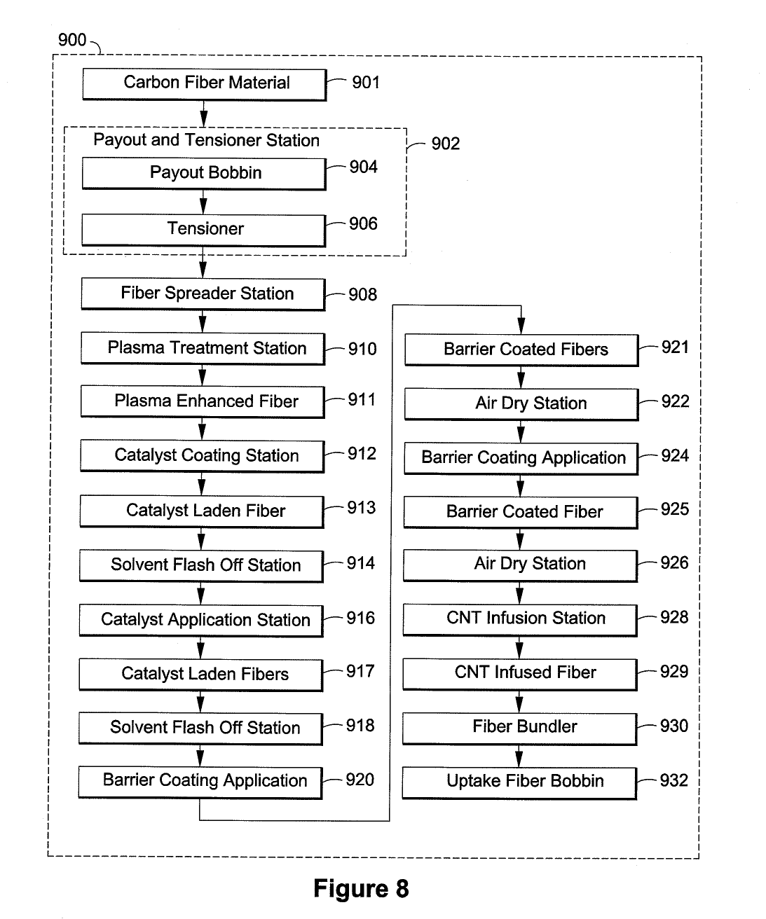

FIG. 8 depicts system 800 for producing CNT-infused fiber in accordance with the illustrative embodiment of the present invention. System 800 includes a carbon fiber material payout and tensioner station 805, sizing removal and fiber spreader station 810, plasma treatment station 815, barrier coating application station 820, air dry station 825, catalyst application station 830, solvent flash-off station 835, CNT-infusion station 840, fiber bundler station 845, and carbon fiber material uptake bobbin 850, interrelated as shown.

Payout and tension station 805 includes payout bobbin 806 and tensioner 807. The payout bobbin delivers carbon fiber material 860 to the process; the fiber is tensioned via tensioner 807. For this example, the carbon fiber is processed at a linespeed of 2 ft/min.

Fiber material 860 is delivered to sizing removal and fiber spreader station 810 which includes sizing removal heaters 865 and fiber spreader 870. At this station, any “sizing” that is on fiber 860 is removed. Typically, removal is accomplished by burning the sizing off of the fiber. Any of a variety of heating means can be used for this purpose, including, for example, an infrared heater, a muffle furnace, and other non-contact heating processes. Sizing removal can also be accomplished chemically. The fiber spreader separates the individual elements of the fiber. Various techniques and apparatuses can be used to spread fiber, such as pulling the fiber over and under flat, uniform-diameter bars, or over and under variable-diameter bars, or over bars with radially-expanding grooves and a kneading roller, over a vibratory bar, etc. Spreading the fiber enhances the effectiveness of downstream operations, such as plasma application, barrier coating application, and catalyst application, by exposing more fiber surface area.

Multiple sizing removal heaters 865 can be placed throughout the fiber spreader 870 which allows for gradual, simultaneous desizing and spreading of the fibers. Payout and tension station 805 and sizing removal and fiber spreader station 810 are routinely used in the fiber industry; those skilled in the art will be familiar with their design and use.

The temperature and time required for burning off the sizing vary as a function of (1) the sizing material and (2) the commercial source/identity of carbon fiber material 860. A conventional sizing on a carbon fiber material can be removed at about 650° C. At this temperature, it can take as long as 15 minutes to ensure a complete burn off of the sizing. Increasing the temperature above this burn temperature can reduce burn-off time. Thermogravimetric analysis is used to determine minimum burn-off temperature for sizing for a particular commercial product.

Depending on the timing required for sizing removal, sizing removal heaters may not necessarily be included in the CNT-infusion process proper; rather, removal can be performed separately (e.g., in parallel, etc.). In this way, an inventory of sizing-free carbon fiber material can be accumulated and spooled for use in a CNT-infused fiber production line that does not include fiber removal heaters. The sizing-free fiber is then spooled in payout and tension station 805. This production line can be operated at higher speed than one that includes sizing removal.

Unsized fiber 880 is delivered to plasma treatment station 815. For this example, atmospheric plasma treatment is utilized in a ‘downstream’ manner from a distance of 1 mm from the spread carbon fiber material. The gaseous feedstock is comprised of 100% helium.

Plasma enhanced fiber 885 is delivered to barrier coating station 820. In this illustrative example, a siloxane-based barrier coating solution is employed in a dip coating configuration. The solution is ‘Accuglass T-11 Spin-On Glass’ (Honeywell International Inc., Morristown, N.J.) diluted in isopropyl alcohol by a dilution rate of 40 to 1 by volume. The resulting barrier coating thickness on the carbon fiber material is approximately 40 nm. The barrier coating can be applied at room temperature in the ambient environment.

Barrier coated carbon fiber 890 is delivered to air dry station 825 for partial curing of the nanoscale barrier coating. The air dry station sends a stream of heated air across the entire carbon fiber spread. Temperatures employed can be in the range of 100° C. to about 500° C.

After air drying, barrier coated carbon fiber 890 is delivered to catalyst application station 830. In this example, an iron oxide-based CNT forming catalyst solution is employed in a dip coating configuration. The solution is ‘EFH-1 ’ (Ferrotec Corporation, Bedford, N.H.) diluted in hexane by a dilution rate of 200 to 1 by volume. A monolayer of catalyst coating is achieved on the carbon fiber material. ‘EFH-1 ’ prior to dilution has a nanoparticle concentration ranging from 3-15% by volume. The iron oxide nanoparticles are of composition Fe2O3 and Fe3O4 and are approximately 8 nm in diameter.

Catalyst-laden carbon fiber material 895 is delivered to solvent flash-off station 835. The solvent flash-off station sends a stream of air across the entire carbon fiber spread. In this example, room temperature air can be employed in order to flash-off all hexane left on the catalyst-laden carbon fiber material.

After solvent flash-off, catalyst-laden fiber 895 is finally advanced to CNT-infusion station 840. In this example, a rectangular reactor with a 12 inch growth zone is used to employ CVD growth at atmospheric pressure. 98.0% of the total gas flow is inert gas (Nitrogen) and the other 2.0% is the carbon feedstock (acetylene). The growth zone is held at 750° C. For the rectangular reactor mentioned above, 750° C. is a relatively high growth temperature, which allows for the highest growth rates possible.

After CNT-infusion, CNT-infused fiber 897 is re-bundled at fiber bundler station 845. This operation recombines the individual strands of the fiber, effectively reversing the spreading operation that was conducted at station 810.

The bundled, CNT-infused fiber 897 is wound about uptake fiber bobbin 850 for storage. CNT-infused fiber 897 is loaded with CNTs approximately 50 μm in length and is then ready for use in composite materials with enhanced thermal and electrical conductivity.

It is noteworthy that some of the operations described above can be conducted under inert atmosphere or vacuum for environmental isolation. For example, if sizing is being burned off of a carbon fiber material, the fiber can be environmentally isolated to contain off-gassing and prevent damage from moisture. For convenience, in system 800, environmental isolation is provided for all operations, with the exception of carbon fiber material payout and tensioning, at the beginning of the production line, and fiber uptake, at the end of the production line.

### Example II

This example shows how carbon fiber material can be infused with CNTs in a continuous process to target improvements in mechanical properties, especially interfacial characteristics such as shear strength. In this case, loading of shorter CNTs on fibers is targeted. In this example, 34-700 12 k unsized carbon fiber tow with a tex value of 793 (Grafil Inc., Sacramento, Calif.) is implemented as the carbon fiber substrate. The individual filaments in this carbon fiber tow have a diameter of approximately 7 μm.

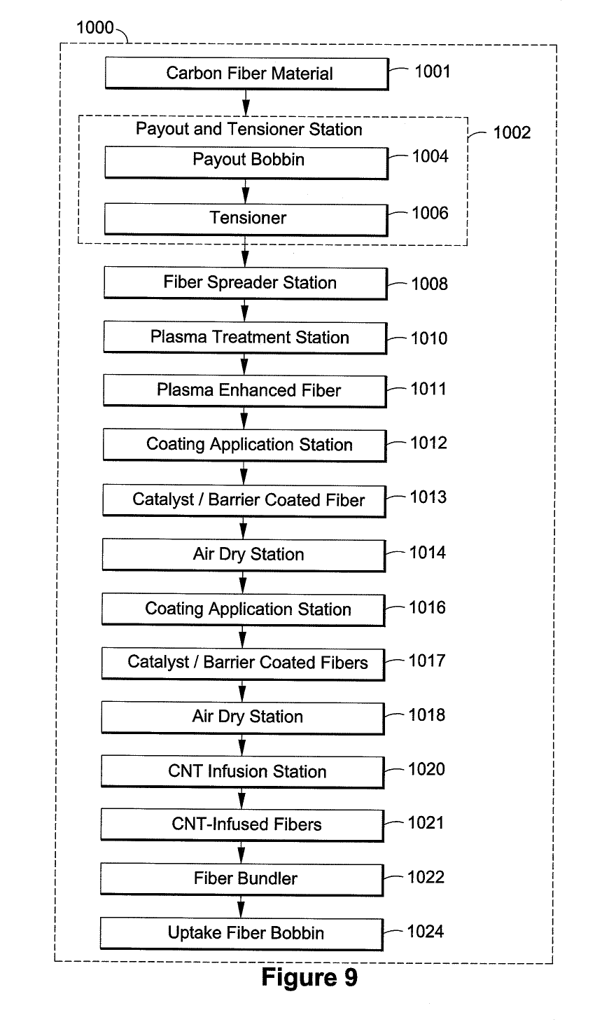

FIG. 9 depicts system 900 for producing CNT-infused fiber in accordance with the illustrative embodiment of the present invention, and involves many of the same stations and processes described in system 800. System 900 includes a carbon fiber material payout and tensioner station 902, fiber spreader station 908, plasma treatment station 910, catalyst application station 912, solvent flash-off station 914, a second catalyst application station 916, a second solvent flash-off station 918, barrier coating application station 920, air dry station 922, a second barrier coating application station 924, a second air dry station 926, CNT-infusion station 928, fiber bundler station 930, and carbon fiber material uptake bobbin 932, interrelated as shown.

Payout and tension station 902 includes payout bobbin 904 and tensioner 906. The payout bobbin delivers carbon fiber material 901 to the process; the fiber is tensioned via tensioner 906. For this example, the carbon fiber is processed at a linespeed of 2 ft/min.

Fiber material 901 is delivered to fiber spreader station 908. As this fiber is manufactured without sizing, a sizing removal process is not incorporated as part of fiber spreader station 908. The fiber spreader separates the individual elements of the fiber in a similar manner as described in fiber spreader 870.

Fiber material 901 is delivered to plasma treatment station 910. For this example, atmospheric plasma treatment is utilized in a ‘downstream’ manner from a distance of 12 mm from the spread carbon fiber material. The gaseous feedstock is comprised of oxygen in the amount of 1.1% of the total inert gas flow (helium). Controlling the oxygen content on the surface of carbon fiber material is an effective way of enhancing the adherence of subsequent coatings, and is therefore desirable for enhancing mechanical properties of a carbon fiber composite.

Plasma enhanced fiber 911 is delivered to catalyst application station 912. In this example, an iron oxide based CNT forming catalyst solution is employed in a dip coating configuration. The solution is ‘EFH-1 ’ (Ferrotec Corporation, Bedford, N.H.) diluted in hexane by a dilution rate of 200 to 1 by volume. A monolayer of catalyst coating is achieved on the carbon fiber material. ‘EFH-1 ’ prior to dilution has a nanoparticle concentration ranging from 3-15% by volume. The iron oxide nanoparticles are of composition Fe2O3 and Fe3O4 and are approximately 8 nm in diameter.

Catalyst-laden carbon fiber material 913 is delivered to solvent flash-off station 914. The solvent flash-off station sends a stream of air across the entire carbon fiber spread. In this example, room temperature air can be employed in order to flash-off all hexane left on the catalyst-laden carbon fiber material.

After solvent flash-off, catalyst laden fiber 913 is delivered to catalyst application station 916, which is identical to catalyst application station 912. The solution is ‘EFH-1 ’ diluted in hexane by a dilution rate of 800 to 1 by volume. For this example, a configuration which includes multiple catalyst application stations is utilized to optimize the coverage of the catalyst on the plasma enhanced fiber 911.

Catalyst-laden carbon fiber material 917 is delivered to solvent flash-off station 918, which is identical to solvent flash-off station 914.

After solvent flash-off, catalyst-laden carbon fiber material 917 is delivered to barrier coating application station 920. In this example, a siloxane-based barrier coating solution is employed in a dip coating configuration. The solution is ‘Accuglass T-11 Spin-On Glass’ (Honeywell International Inc., Morristown, N.J.) diluted in isopropyl alcohol by a dilution rate of 40 to 1 by volume. The resulting barrier coating thickness on the carbon fiber material is approximately 40 nm. The barrier coating can be applied at room temperature in the ambient environment.

Barrier coated carbon fiber 921 is delivered to air dry station 922 for partial curing of the barrier coating. The air dry station sends a stream of heated air across the entire carbon fiber spread. Temperatures employed can be in the range of 100° C. to about 500° C.

After air drying, barrier coated carbon fiber 921 is delivered to barrier coating application station 924, which is identical to barrier coating application station 820. The solution is ‘Accuglass T-11 Spin-On Glass’ diluted in isopropyl alcohol by a dilution rate of 120 to 1 by volume. For this example, a configuration which includes multiple barrier coating application stations is utilized to optimize the coverage of the barrier coating on the catalyst-laden fiber 917.

Barrier coated carbon fiber 925 is delivered to air dry station 926 for partial curing of the barrier coating, and is identical to air dry station 922.

After air drying, barrier coated carbon fiber 925 is finally advanced to CNT-infusion station 928. In this example, a rectangular reactor with a 12 inch growth zone is used to employ CVD growth at atmospheric pressure. 97.75% of the total gas flow is inert gas (Nitrogen) and the other 2.25% is the carbon feedstock (acetylene). The growth zone is held at 650° C. For the rectangular reactor mentioned above, 650° C. is a relatively low growth temperature, which allows for the control of shorter CNT growth.

After CNT-infusion, CNT-infused fiber 929 is re-bundled at fiber bundler 930. This operation recombines the individual strands of the fiber, effectively reversing the spreading operation that was conducted at station 908.

The bundled, CNT-infused fiber 931 is wound about uptake fiber bobbin 932 for storage. CNT-infused fiber 929 is loaded with CNTs approximately 5 μm in length and is then ready for use in composite materials with enhanced mechanical properties.

In this example, the carbon fiber material passes through catalyst application stations 912 and 916 prior to barrier coating application stations 920 and 924. This ordering of coatings is in the ‘reverse’ order as illustrated in Example I, which can improve anchoring of the CNTs to the carbon fiber substrate. During the CNT growth process, the barrier coating layer is lifted off of the substrate by the CNTs, which allows for more direct contact with the carbon fiber material (via catalyst NP interface). Because increases in mechanical properties, and not thermal/electrical properties, are being targeted, a ‘reverse’ order coating configuration is desirable.

It is noteworthy that some of the operations described above can be conducted under inert atmosphere or vacuum for environmental isolation. For convenience, in system 900, environmental isolation is provided for all operations, with the exception of carbon fiber material payout and tensioning, at the beginning of the production line, and fiber uptake, at the end of the production line.

### Example III

This example shows how carbon fiber material can be infused with CNTs in a continuous process to target improvements in mechanical properties, especially interfacial characteristics such as interlaminar shear.

In this example, loading of shorter CNTs on fibers is targeted. In this example, 34-700 12 k unsized carbon fiber tow with a tex value of 793 (Grafil Inc., Sacramento, Calif.) is implemented as the carbon fiber substrate. The individual filaments in this carbon fiber tow have a diameter of approximately 7 μm.

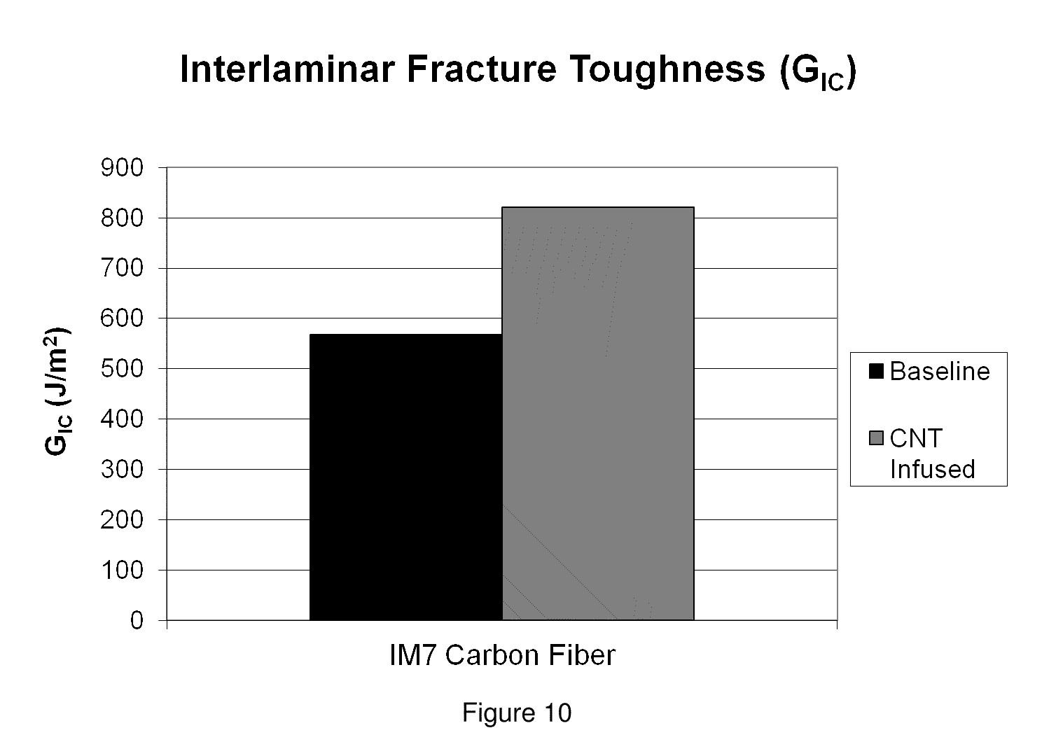

FIG. 10 depicts system 1000 for producing CNT-infused fiber in accordance with the illustrative embodiment of the present invention, and involves many of the same stations and processes described in system 800. System 1000 includes a carbon fiber material payout and tensioner station 1002, fiber spreader station 1008, plasma treatment station 1010, coating application station 1012, air dry station 1014, a second coating application station 1016, a second air dry station 1018, CNT-infusion station 1020, fiber bundler station 1022, and carbon fiber material uptake bobbin 1024, interrelated as shown.

Payout and tension station 1002 includes payout bobbin 1004 and tensioner 1006. The payout bobbin delivers carbon fiber material 1001 to the process; the fiber is tensioned via tensioner 1006. For this example, the carbon fiber is processed at a linespeed of 5 ft/min.

Fiber material 1001 is delivered to fiber spreader station 1008. As this fiber is manufactured without sizing, a sizing removal process is not incorporated as part of fiber spreader station 1008. The fiber spreader separates the individual elements of the fiber in a similar manner as described in fiber spreader 870.

Fiber material 1001 is delivered to plasma treatment station 1010. For this example, atmospheric plasma treatment is utilized in a ‘downstream’ manner from a distance of 12 mm from the spread carbon fiber material. The gaseous feedstock is comprised of oxygen in the amount of 1.1% of the total inert gas flow (helium). Controlling the oxygen content on the surface of carbon fiber material is an effective way of enhancing the adherence of subsequent coatings, and is therefore desirable for enhancing mechanical properties of a carbon fiber composite.

Plasma enhanced fiber 1011 is delivered to coating application station 1012. In this example, an iron oxide based catalyst and a barrier coating material is combined into a single ‘hybrid’ solution and is employed in a dip coating configuration. The ‘hybrid’ solution is 1-part-by-volume ‘EFH-1’, 5-parts ‘Accuglass T-11 Spin-On Glass’, 24-parts hexane, 24-parts isopropyl alcohol, and 146-parts tetrahydrofuran. The benefit of employing such a ‘hybrid’ coating is that it marginalizes the effect of fiber degradation at high temperatures. Without being bound by theory, degradation to carbon fiber materials is intensified by the sintering of catalyst NPs at high temperatures (the same temperatures vital to the growth of CNTs). By encapsulating each catalyst NP with its own barrier coating, it is possible to control this effect. Because increases in mechanical properties, and not thermal/electrical properties, is being targeted, it is desirable to maintain the integrity of the carbon fiber base-material, therefore a ‘hybrid’ coating can be employed.

Catalyst-laden and barrier coated carbon fiber material 1013 is delivered to air dry station 1014 for partial curing of the barrier coating. The air dry station sends a stream of heated air across the entire carbon fiber spread. Temperatures employed can be in the range of 100° C. to about 500° C.

After air drying, the catalyst and barrier coating-laden carbon fiber 1013 is delivered to coating application station 1016, which is identical to coating application station 1012. The same ‘hybrid’ solution is used (1-part-by-volume ‘EFH-1’, 5-parts ‘Accuglass T-11 Spin-On Glass’, 24-parts hexane, 24-parts isopropyl alcohol, and 146-parts tetrahydrofuran). For this example, a configuration which includes multiple coating application stations is utilized to optimized the coverage of the ‘hybrid’ coating on the plasma enhanced fiber 1011.

Catalyst and barrier coating-laden carbon fiber 1017 is delivered to air dry station 1018 for partial curing of the barrier coating, and is identical to air dry station 1014.

After air drying, catalyst and barrier coating-laden carbon fiber 1017 is finally advanced to CNT-infusion station 1020. In this example, a rectangular reactor with a 12 inch growth zone is used to employ CVD growth at atmospheric pressure. 98.7% of the total gas flow is inert gas (Nitrogen) and the other 1.3% is the carbon feedstock (acetylene). The growth zone is held at 675° C. For the rectangular reactor mentioned above, 675° C. is a relatively low growth temperature, which allows for the control of shorter CNT growth.

After CNT-infusion, CNT-infused fiber 1021 is re-bundled at fiber bundler 1022. This operation recombines the individual strands of the fiber, effectively reversing the spreading operation that was conducted at station 1008.

The bundled, CNT-infused fiber 1021 is wound about uptake fiber bobbin 1024 for storage. CNT-infused fiber 1021 is loaded with CNTs approximately 2 μm in length and is then ready for use in composite materials with enhanced mechanical properties.

It is noteworthy that some of the operations described above can be conducted under inert atmosphere or vacuum for environmental isolation. For convenience, in system 1000, environmental isolation is provided for all operations, with the exception of carbon fiber material payout and tensioning, at the beginning of the production line, and fiber uptake, at the end of the production line.

### Example IV

This example shows how carbon fiber material was infused with CNTs in a continuous process and was then incorporated into a C—C paper to demonstrate improvements to specific surface area for electrode applications.

In this example, a higher loading of CNTs on fibers was targeted. In this example, HexTow® IM7 12 k unsized carbon fiber tow with a tex value of 446 (Hexcel Corporation, Stamford, Conn.) was implemented as the carbon fiber substrate. The individual filaments in this carbon fiber tow have a diameter of approximately 5.2 μm.

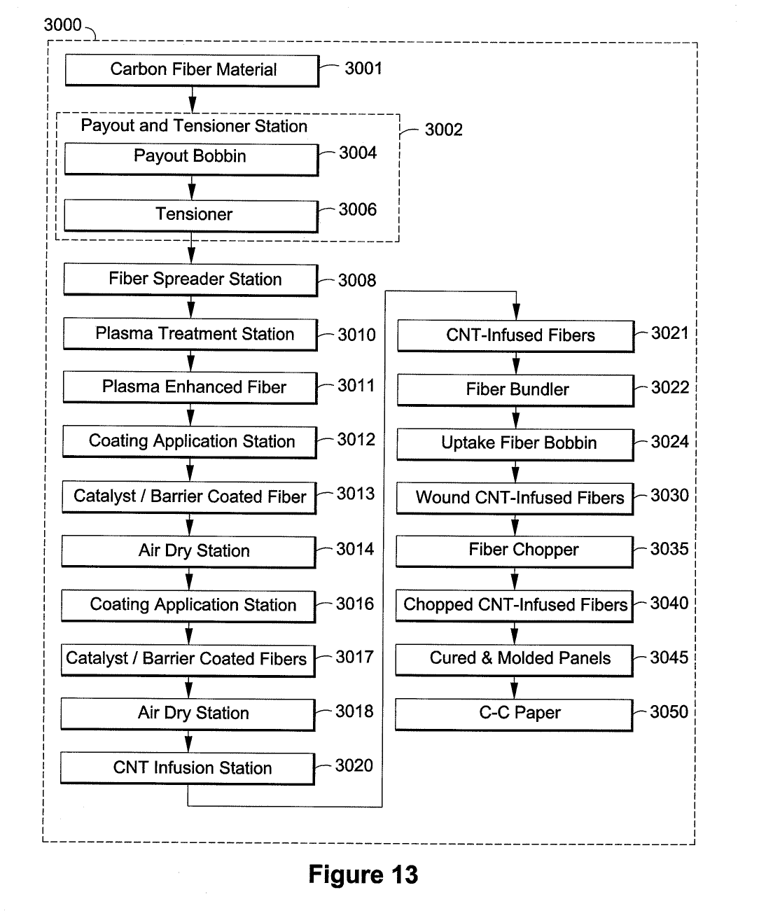

FIG. 13 depicts system 3000 for producing CNT-infused fiber in accordance with the illustrative embodiment of the present invention. System 3000 included a carbon fiber material payout and tensioner station 3002, fiber spreader station 3008, plasma treatment station 3010, coating application station 3012, air dry station 3014, a second coating application station 3016, a second air dry station 3018, CNT-infusion station 3020, fiber bundler station 3022, carbon fiber material uptake bobbin 3024, and fiber chopper 3035 interrelated as shown.

Payout and tension station 3002 included payout bobbin 3004 and tensioner 3006. The payout bobbin delivered carbon fiber material 3001 to the process; the fiber was tensioned via tensioner 3006. For this example, the carbon fiber was processed at a linespeed of 0.5 ft/min at a tension of 320 grams.

Fiber material 3001 was delivered to fiber spreader station 3008. As this fiber was manufactured without sizing, a sizing removal process was not incorporated as part of fiber spreader station 3008. The fiber spreader separated the individual elements of the fiber to a distance of 4 inches in a similar manner as described for fiber spreader 870.

Fiber material 3001 was delivered to plasma treatment station 3010. In this process run, atmospheric plasma treatment was utilized in a ‘downstream’ manner from a distance of 12 mm from the spread carbon fiber material. The plasma gas flow consisted of 100% helium flowing at a rate of 20 slpm.

Plasma enhanced fiber 3011 was delivered to coating application station 3012. In this process run, an iron oxide-based catalyst and a barrier coating material was combined into a single ‘hybrid’ solution and was employed in a dip coating configuration. The ‘hybrid’ solution was 1-part-by-volume ‘EFH-1’, 5-parts ‘Accuglass T-11 Spin-On Glass’, 24-parts hexane, 24-parts isopropyl alcohol, and 146-parts tetrahydrofuran. The benefit of employing such a ‘hybrid’ coating was that it marginalizes the effect of fiber degradation at high temperatures.

Catalyst-laden and barrier coated carbon fiber material 3013 were delivered to air dry station 3014 for partial curing of the barrier coating. The air dry station sent a stream of heated air across the entire carbon fiber spread. Temperatures employed 300° C.

After air drying, the catalyst and barrier coating-laden carbon fiber 3013 was delivered to coating application station 3016, which is identical to coating application station 3012. The same ‘hybrid’ solution was used (1-part-by-volume ‘EFH-1’, 5-parts ‘Accuglass T-11 Spin-On Glass’, 24-parts hexane, 24-parts isopropyl alcohol, and 146-parts tetrahydrofuran). For this example, a configuration which included multiple coating application stations was utilized to optimized the coverage of the ‘hybrid’ coating on the plasma enhanced fiber 3011.

Catalyst and barrier coating-laden carbon fiber 3017 was delivered to air dry station 3018 for partial curing of the barrier coating, which was identical to air dry station 3014.

After air drying, catalyst and barrier coating-laden carbon fiber 3017 was then advanced to CNT-infusion station 3020. In this process run, a rectangular reactor with a 24 inch growth zone was used to employ CVD growth at atmospheric pressure. 98.0% of the total gas flow was inert gas (Nitrogen) and the other 2.0% was the carbon feedstock (acetylene). The growth zone was held at 750° C. For the rectangular reactor mentioned above, 750° C. was a relatively high growth temperature to use which allowed for the control of longer CNT growth.

After CNT-infusion, CNT-infused fiber 3021 was re-bundled at fiber bundler 3022. This operation recombined the individual strands of the fiber, effectively reversing the spreading operation that was conducted at station 3008.

The bundled, CNT-infused fiber 3021 was then wound about uptake fiber bobbin 3024 to make it easier to transport to fiber chopper 3035.

Wound CNT-infused fiber 3030 was then ran through fiber chopper 3035. Chopped CNT-infused fiber 3040 was produced at two different lengths (3 mm and 6 mm).

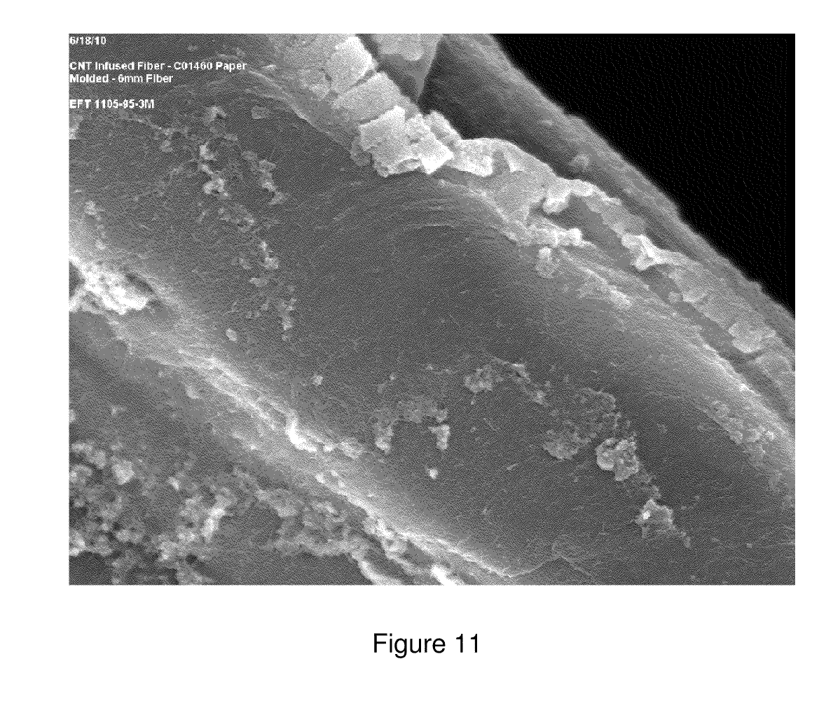

Chopped CNT-infused fiber 3040 of both fiber lengths was mixed with phenolic resin at a ratio of 65% weight resin and 35% weight fiber. The resulting material was cured and molded into a square panel at 180° C. under 200 psi of pressure for 5 hours. The resulting molded and cured phenolic panel is shown in FIG. 11 for the 6 mm long chopped CNT-infused fiber 3040.

Cured and molded panels 3045 were then placed in an oven under inert (nitrogen) atmosphere where the panels were exposed to temperatures of 950° C. for 3 hours to initiate the carbonization or pyrolysis process. Only a single pyrolysis step was completed in this process in order to create voids which improved the overall specific surface area.

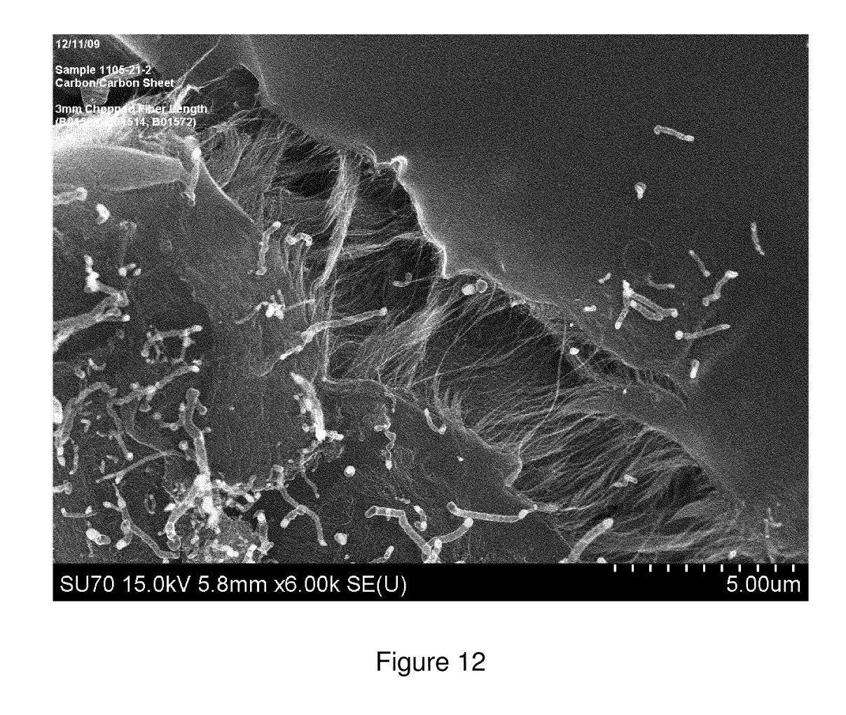

C—C paper 3050 was created using both 3 mm and 6 mm chopped CNT-infused fiber 3040. An example of the C—C matrix with CNTs included for a 3 mm chopped fiber is shown in FIG. 12. The specific surface areas associated with 3 mm and 6 mm C—C papers were 257 m2/g and 284 m2/g respectively.

It is noteworthy that some of the operations described above can be conducted under inert atmosphere or vacuum for environmental isolation. For convenience, in system 1000, environmental isolation is provided for all operations, with the exception of carbon fiber material payout and tensioning, at the beginning of the production line, and fiber uptake, at the end of the production line.

Although the invention has been described with reference to the disclosed embodiments, those skilled in the art will readily appreciate that these only illustrative of the invention. It should be understood that various modifications can be made without departing from the spirit of the invention.

What is claimed is:

1. A carbon/carbon (C/C) composite comprising a carbon matrix and a non-woven, carbon nanotube (CNT)-infused carbon fiber material.

2. The C/C composite of claim 1, wherein said non-woven, CNT-infused carbon fiber material is a continuous CNT-infused carbon fiber material.

3. The C/C composite of claim 1, wherein said non-woven, CNT-infused carbon fiber material is a chopped CNT-infused carbon fiber material.

4. The C/C composite of claim 1, wherein said carbon matrix is derived from an organic resin.

5. The C/C composite of claim 1, wherein the carbon matrix is derived from a tar or pitch.

6. The C/C composite of claim 1, further comprising a matrix modifier comprising phosphorus or boron.

7. The C/C composite of claim 1, further comprising a dopant carbon nanostructure selected from the group consisting of loose CNTs, fullerenes, nano-onions, nanoflakes, nanoscrolls, nanopaper, nanofibers, nanohorns, nanoshells, nanowires, nanosprings, nanocrystals, nanodiamonds, bucky diamond, nanocontainers, nanomesh, nanosponges, nano-scaled graphene plates (NGPs), and nanobeads.

8. The C/C composite of claim 1, wherein a CNT density on said non-woven CNT-infused carbon fiber material is in a range from between about 100 CNTs per micron squared to about 10,000 CNTs per micron squared.

9. The C/C composite of claim 1, wherein a CNT density on said CNT-infused carbon fiber material is in a range from between about 100 CNTs per micron squared to about 5,000 CNTs per micron squared.

10. The C/C composite of claim 1, wherein CNTs of said CNT-infused fiber material range in length from between about 0.1 microns to about 500 microns.

11. The C/C composite of claim 1, wherein CNTs of said CNT-infused fiber material range in length from between about 250 to about 500 microns.

12. The C/C composite of claim 1, wherein CNTs of said CNT-infused fiber material range in length from between about 50 to about 250 microns.

13. The C/C composite of claim 1, wherein CNTs of said CNT-infused fiber material are present in a range from between about 0.5 percent by weight to about 40 percent by weight of said CNT-infused fiber.

14. The C/C composite of claim 1, wherein CNTs of said CNT-infused fiber material are present in a range from between about 35 percent by weight to about 40 percent by weight of said CNT-infused fiber.

15. The C/C composite of claim 1, wherein CNTs of said CNT-infused fiber material are present in a range from between about 15 percent by weight to about 30 percent by weight of said CNT-infused fiber.

16. The C/C composite of claim 1, wherein said composite has a CNT-infused fiber material volume in a range from between about 0.5% percent to about 60 percent of the composite volume.

17. The C/C composite of claim 1, wherein said composite has a CNT-infused fiber material volume in a range from between about 30 percent to about 40 percent of the composite volume.

18. A C/C composite comprising a carbon matrix and a CNT-infused carbon fiber material; wherein if said CNT-infused carbon fiber material is woven, CNTs are infused on a parent carbon fiber material in a non-woven state.

19. A C/C composite made by the process of growing CNTs on a spread carbon fiber tow to provide a CNT-infused carbon fiber tow, shaping the CNT-infused carbon fiber tow, and forming a carbon matrix about the shaped CNT-infused carbon fiber tow.

20. A C/C composite comprising a carbon matrix and a CNT-infused carbon fiber material, said CNT-infused carbon fiber material comprising a barrier coating.

21. An article comprising a carbon/carbon (C/C) composite comprising a carbon matrix and a non-woven CNT-infused carbon fiber material.

22. The article of claim 21, wherein said CNT-infused carbon fiber material is continuous.

23. The article of claim 21, wherein said CNT-infused carbon fiber material is chopped.

24. The article of claim 21, further comprising a protective coating, a matrix modifier, or mixtures thereof.

25. The article of claim 24, wherein said protective coating is a metal or metalloid in a form selected from an oxide, carbide, nitride, silicide, and combinations thereof.

26. The article of claim 24, wherein said matrix modifier comprises boron or phosphorus.

27. The article of claim 21, wherein said article is a brake rotor.

28. The article of claim 21, wherein said article is a portion of a hypersonic aircraft.

29. A method of making a C/C composite comprising a CNT-infused carbon fiber in a carbon matrix, the method comprising:
winding a continuous CNT-infused carbon fiber about a template structure; and
forming a carbon matrix to provide an initial C/C composite.

30. The method of claim 29, wherein the step of forming a carbon matrix comprises infusing the wound continuous CNT-infused carbon fiber material with a carbon matrix precursor followed by pyrolysis of the carbon matrix precursor.

31. The method of claim 30, wherein the carbon matrix precursor is an organic resin.

32. The method of claim 31, wherein the organic resin is a phenolic resin.

33. The method of claim 30 wherein the carbon matrix precursor is a tar or pitch.

34. The method of claim 29, wherein the winding step comprises wet winding with a carbon matrix precursor and the forming step comprises pyrolysis.

35. The method of claim 29, wherein forming the carbon matrix comprises chemical vapor deposition (CVD) and/or chemical vapor infiltration (CVI).

36. The method of claim 29, further comprising densifying said initial C/C composite.

37. The method of claim 36, wherein densifying comprises subjecting said initial C/C composite to repeated cycles of infusion with a carbon matrix precursor and pyrolysis.

38. The method of claim 36, wherein densifying comprises subjecting said C/C composite to repeated cycles of CVD and/or CVI.

39. The method of claim 36, wherein densifying comprises disposing a CNT growth catalyst on said initial C/C composite and subjecting the catalyst-laden initial C/C composite to CVD conditions that include a temperature ramp comprising temperatures for promoting CNT growth up to temperatures for carbonization.

40. A method of making a C/C composite comprising a CNT-infused carbon fiber in a carbon matrix, the method comprising:
dispersing chopped CNT-infused carbon fibers in a carbon matrix precursor to provide a mixture;
placing said mixture in a mold; and
forming a carbon matrix to provide an initial C/C composite.

41. The method of claim 40, wherein the step of forming a carbon matrix comprises pyrolyzing the carbon matrix precursor.

42. The method of claim 40, wherein the carbon matrix precursor is an organic resin.

43. The method of claim 42, wherein the organic resin is a phenolic resin.

44. The method of claim 40, wherein the carbon matrix precursor is a tar or pitch.

45. The method of claim 40, further comprising densifying said initial C/C composite.

46. The method of claim 45, wherein densifying comprises subjecting said initial C/C composite to repeated cycles of infusion with a carbon matrix precursor and pyrolysis.

47. The method of claim 45, wherein densifying comprises subjecting said C/C composite to repeated cycles of CVD.

48. The method of claim 45, wherein densifying comprises disposing a CNT growth catalyst on said initial C/C composite and subjecting the catalyst-laden initial C/C composite to CVD conditions that include a temperature ramp comprising temperatures for promoting CNT growth up to temperatures for carbonization.
